(19) United States
(12) Patent Application Publication
(10) Pub. No.: US 2026/0289707 A1
(43) Pub. Date: Sep. 24, 2026

(54) SYSTEM

(71) Applicant: SoftBank Group Corp., Tokyo (JP)

(72) Inventor: Nobufusa KOBAYASHI, Tokyo (JP)

(73) Assignee: SoftBank Group Corp., Tokyo (JP)

(21) Appl. No.: 19/568,894

(22) Filed: Mar. 17, 2026

(30) Foreign Application Priority Data
Mar. 19, 2025 (JP) 2025-044927

(51) Int. Cl. G06Q 50/18; G06N 3/0475

(52) U.S. Cl. CPC G06Q 50/186; G06N 3/0475

(57) ABSTRACT

A system includes a processor that is configured to: receive inheritance-related information from a decedent and from an heir; analyze the received information by using a natural language processing technique; and input a prompt sentence to a generative AI model based on a result of the analysis so as to automatically generate a required procedure or a required document.

### CROSS-REFERENCE TO RELATED APPLICATION

This application is based on and claims priority under 35 USC 119 from Japanese Patent Application No. 2025-044927 filed on Mar. 19, 2025, the disclosure of which is incorporated by reference herein.

### BACKGROUND

### Technical Field

The Present Disclosure Relates to a System.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional inheritance procedures impose a significant burden on both a decedent, who is required to make preparations during life, and an heir, who must perform complex and time-consuming administrative tasks after the decedent's death. In particular, property inheritance involves the collection and interpretation of diverse information, the selection and execution of legally required procedures, and the preparation of multiple documents for submission to various institutions. These tasks are often performed manually, require specialized legal and tax knowledge, and are prone to omissions and errors. Furthermore, end-of-life handling of social networking service accounts has recently become an additional source of psychological and operational burden on heirs, because each service has its own procedures for account deletion, memorialization, or death notification. Existing systems do not sufficiently utilize natural language processing and generative AI models to automatically interpret inheritance-related information provided in natural language, to generate appropriate procedures and documents, and to perform integrated support that includes both property inheritance and social networking service end-of-life processing. Therefore, there is a need for a system capable of reducing the burden on the decedent and the heir by automatically processing inheritance-related information expressed in natural language and by digitizing and integrating property inheritance tasks and social networking service end-of-life support.

### SUMMARY

According to one aspect of the present invention, a system is provided that comprises a processor, wherein the processor is configured to receive inheritance-related information from a decedent and from an heir, analyze the received information by using a natural language processing technique, and input a prompt sentence to a generative AI model based on a result of the analysis so as to automatically generate a required procedure or a required document. In addition, the processor is configured to reduce a burden on the decedent and on the heir by digitizing and integrating a task or a procedure related to property inheritance, for example by electronically managing a series of inheritance-related workflows, automatically generating documents needed for submission to external institutions, and presenting them to the decedent or the heir through an appropriate user interface. Furthermore, the processor is configured to provide end-of-life support for a social networking service by generating, by using the generative AI model, a prompt for performing deletion of the social networking service or for providing a death notification with respect to the social networking service, thereby automatically executing or assisting in the execution of procedures required by each social networking service provider. By these means, the system automatically interprets inheritance-related information provided in natural language, automatically generates necessary procedures and documents, and centrally manages both property inheritance workflows and social networking service end-of-life tasks, thus effectively solving the above-mentioned problems.

The term “system” refers to an information processing apparatus, which may be implemented by one or more physical machines, configured to execute the functions described in the present specification and claims.

The term “processor” refers to one or more hardware processing units, such as a central processing unit (CPU), a graphics processing unit (GPU), an application specific integrated circuit (ASIC), or a programmable logic device, and includes any combination thereof, configured to execute computer-executable instructions to realize the claimed functions.

The term “inheritance-related information” refers to information associated with an inheritance process, including at least one of information about a decedent, information about an heir, information about assets or liabilities, information about wills or inheritance agreements, and information about desired procedures or instructions relating to property succession.

The term “decedent” refers to a person whose property, rights, or obligations are subject to an inheritance process, and includes a person who is preparing in advance for such inheritance prior to death.

The term “heir” refers to a person or entity that is entitled, by law, contract, or other arrangement, to receive property, rights, or obligations from a decedent in an inheritance process.

The term “natural language processing technique” refers to a computational method or algorithm for processing, analyzing, understanding, or generating human languages, such as tokenization, part-of-speech tagging, syntactic or semantic analysis, information extraction, intent detection, or text classification.

The term “generative AI model” refers to a machine learning model, such as a large language model or another generative model trained on data, configured to generate text, documents, or other content in response to an input prompt.

The term “prompt sentence” refers to a text string or other input data provided to the generative AI model, the content and structure of which guide the generative AI model to produce an output related to a required procedure or a required document.

The term “required procedure” refers to an action or set of actions that should be taken in connection with an inheritance process, including but not limited to legal, administrative, or tax procedures, and further including steps to be performed at external institutions.

The term “required document” refers to a document that should be created, completed, or submitted in connection with an inheritance process, including but not limited to agreements, applications, notifications, tax-related forms, and supporting documents for external institutions.

The term “digitizing” refers to converting at least a part of a task, a procedure, or associated data from a manual or paper-based form into an electronic form that can be processed, stored, or transmitted by the system.

The term “integrating” refers to managing, in a unified manner within the system, a plurality of tasks, procedures, or data items that would otherwise be processed separately, such that the tasks or procedures can be coordinated, tracked, or controlled as a whole.

The term “property inheritance” refers to a process in which assets, liabilities, rights, or obligations of a decedent are succeeded to one or more heirs, in accordance with applicable laws, contracts, or instructions.

The term “social networking service” refers to an online service, platform, or site that enables users to create accounts, generate and share content, and interact with other users over a network.

The term “end-of-life support for a social networking service” refers to support for handling a user's social networking service account in connection with the user's death, including at least one of account deletion, memorialization, restriction of access, and notification of death to other users or to the service provider.

The term “deletion of the social networking service” refers to a process of causing a social networking service provider to delete or deactivate an account associated with a deceased user, including removal or inaccessibility of stored content of the account.

The term “death notification with respect to the social networking service” refers to a process of providing, through the social networking service or to the social networking service provider, information indicating that a user associated with an account has died, including at least one of public posts, private messages, or formal notifications required by the provider.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

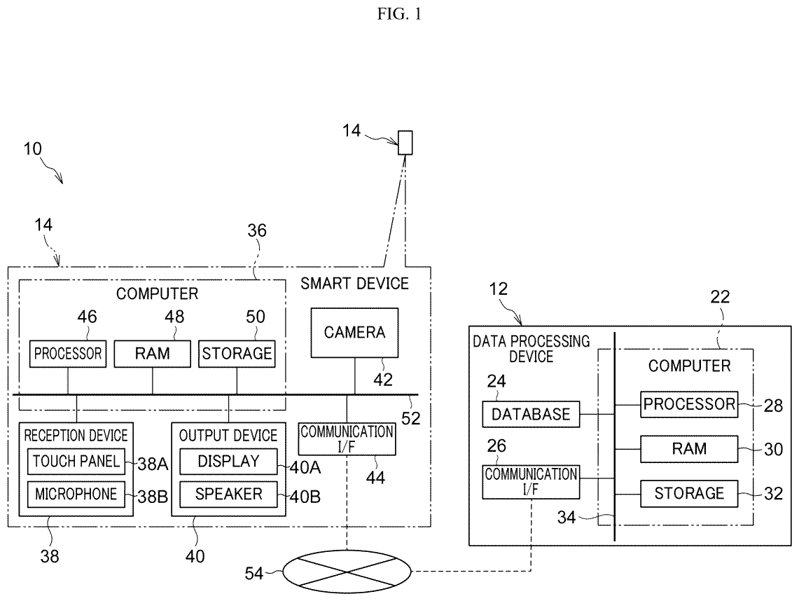

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

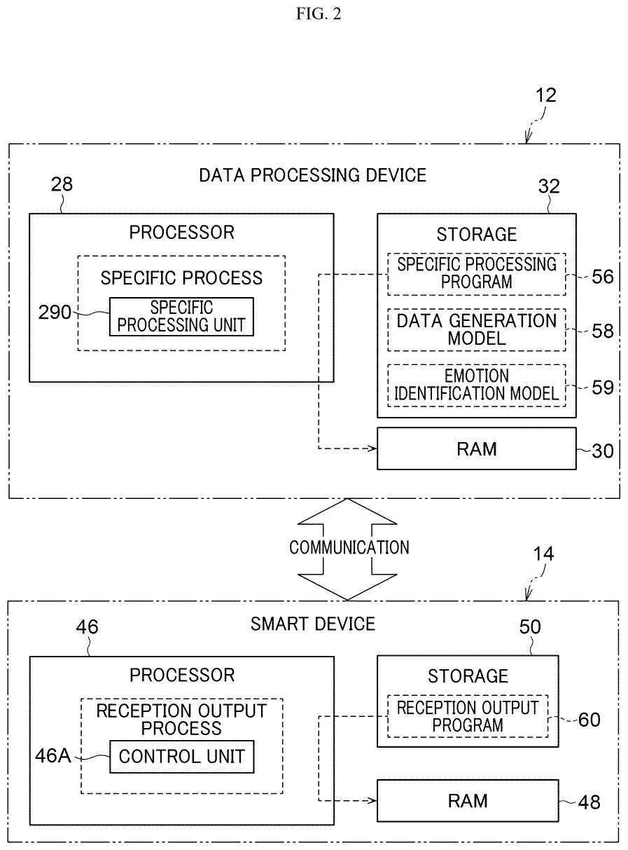

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information processing systems for property succession rely on rigid, rule-based workflows and manually designed forms. In such systems, a processor typically executes fixed control logic that maps pre-defined user inputs to pre-defined document templates and procedure lists. When the user describes a succession case in natural language, the system often cannot accurately interpret nuances such as relationships among parties, complex asset compositions, jurisdiction-specific requirements, or exceptional conditions. As a result, human operators must frequently intervene to interpret the case, identify the relevant procedures, and manually draft or revise documents, which leads to latency, inconsistencies, and a high error rate in the generated outputs.

Moreover, known systems treat natural language input, structured form data, and back-end workflow status as separate silos. The processor generally does not integrate these heterogeneous data types into a unified, machine-interpretable representation that can be used to dynamically drive downstream document generation, external submission, and progress tracking. This separation limits the ability of the system to automatically adapt to incomplete or corrected information, and often forces the user to re-enter duplicative information for different stages of the process.

In addition, existing uses of machine learning or language models in back-office processing are typically limited to auxiliary recommendation tasks, such as suggesting text fragments, without being tightly integrated into the core control flow of the succession procedure management. In many cases, a language model is invoked in an ad-hoc fashion, with unstructured prompts and outputs that are not systematically mapped into internal procedure types or document structures. This lack of structured interaction between the processor, the language model, and the storage device prevents the system from achieving robust, repeatable, and auditable end-to-end automation.

From the perspective of computer technology, the above limitations manifest as an inefficient interaction between a client terminal and a server, suboptimal utilization of processing resources in the server, and a lack of programmatic mechanisms to transform user-level descriptions into machine-level workflow representations. The processor cannot effectively leverage generative models as a programmable component that receives a well-defined prompt sentence and returns a structured analysis result that can be automatically consumed by downstream modules. Consequently, the system fails to provide a scalable and resource-efficient way to generate, update, and manage large numbers of procedure-specific documents and progress states.

Furthermore, conventional systems are not well designed to handle iterative refinement. When additional or corrected information is received, the processor often cannot automatically regenerate prompts, re-analyze the case, and propagate updates consistently across all affected procedures and documents. This leads to data inconsistency between what is displayed to the user, what is stored in the database, and what is transmitted to external organizations. It also reduces the reliability of the system and imposes unnecessary computational and human overhead in reconciling discrepancies.

There is also a technical deficiency in integrating end-of-life support on social network services with the internal property succession workflow. Existing systems treat social network service operations, such as account closure or death notification, as separate manual tasks, and the processor is not configured to generate or manage these operations on the basis of the same structured analysis that governs the succession procedures. As a result, there is no unified, computer-implemented mechanism that uses a generative model to drive both back-end legal/administrative workflows and front-end social network notifications from a common data and prompt generation pipeline.

Accordingly, there is a need for an improved computer-implemented system in which a processor is specifically configured to: (i) receive and store heterogeneous succession-related information from a terminal; (ii) analyze both natural language and structured information using a natural language processing technique; (iii) automatically construct a structured prompt sentence for a generative AI model; (iv) obtain a structured analysis result from the generative AI model; (v) map that result onto internal procedure types and document structures; (vi) generate and update electronic document data and progress states in a unified manner; and (vii) optionally use the same mechanism to perform end-of-life support operations on social network services. Such a configuration would improve the functioning of the computer system itself by enabling more accurate, efficient, and automated control of complex, stateful workflows driven by generative AI outputs.

The specific processing by the specific processing unit 290 of the data processing device 12 in Example 1 is realized by the following means.

The present invention provides a server comprising a processor and a storage device, the processor being configured to execute instructions to receive, via a terminal, succession-related information regarding property succession, store heterogeneous attributes of parties and property in the storage device, analyze natural language and structured data by a natural language processing technique to identify candidate procedures, automatically generate a structured prompt sentence including explicit role, task, case summary, and output format portions, input the prompt sentence to a generative AI model, obtain a structured analysis result including lists of procedures, required documents, and document drafts, map the analysis result to internal procedure types and document structures, generate electronic document data by filling template data with the mapped drafts and stored attributes, transmit the electronic document data to external organizations via a communication network while updating progress states in the storage device, and notify the updated progress states and document information to the terminal for display. This enables the computer system to transform user-level succession descriptions into machine-level workflow representations driven by a generative AI model in an automated, iterative, and structured manner, thereby improving resource utilization, reducing manual intervention, ensuring consistency of stored and displayed data, and providing an extensible platform for integrating legal workflows and end-of-life support on social network services.

The term “succession-related information” refers to information regarding a property succession case, including at least identification attributes of a transferor, identification attributes of a successor, attributes of property to be succeeded, and preferences or conditions relating to procedures to be performed in the succession.

The term “transferor” refers to a person or legal subject from whom property, rights, or obligations are to be transferred or succeeded in a property succession process.

The term “successor” refers to a person or legal subject who receives or is intended to receive property, rights, or obligations in a property succession process.

The term “attribute information” refers to data representing characteristics of an entity, including but not limited to name information, contact information, relationship information, classification information, valuation information, location information, and temporal information.

The term “property” refers to assets, rights, and obligations that can be the subject of a succession, including, for example, monetary assets, real property, movable property, financial instruments, and contractual rights.

The term “procedural preferences” refers to user-specified conditions or requirements relating to how property succession procedures are to be carried out, including, for example, desired timing, priorities among heirs, and preferences for electronic or physical submission.

The term “terminal” refers to an information processing apparatus used by a user to interact with the system, including a computing device such as a workstation, a portable information terminal, or a communication-capable display device.

The term “storage device” refers to a hardware resource configured to store data under control of a processor, including, for example, a semiconductor memory, a magnetic storage medium, an optical storage medium, or a storage subsystem accessible via a communication network.

The term “natural language” refers to human language expressed in text form, such as sentences or phrases, that is not constrained to formal programming syntax or machine code.

The term “natural language processing technique” refers to a computational method by which a processor analyzes natural language text to extract structured information, such as entities, attributes, relationships, and intents.

The term “candidate procedures” refers to one or more possible legal, administrative, or operational steps that may be required to complete a property succession, as identified by analysis of succession-related information.

The term “prompt sentence” refers to a sequence of machine-readable characters, including one or more portions such as role instructions, task instructions, case summaries, and output format instructions, that is provided as input to a generative AI model.

The term “role instruction portion” refers to a part of a prompt sentence that specifies a function or expertise to be assumed by a generative AI model when generating an output.

The term “task instruction portion” refers to a part of a prompt sentence that specifies a task to be performed by a generative AI model, such as listing procedures, identifying required documents, or drafting document text.

The term “case summary portion” refers to a part of a prompt sentence that summarizes succession-related information in a canonical or structured narrative form for interpretation by a generative AI model.

The term “output format instruction portion” refers to a part of a prompt sentence that specifies a desired structural format, such as listing, tabular form, or structured data format, for an output to be generated by a generative AI model.

The term “generative AI model” refers to a machine-learned model configured to generate text or structured data outputs in response to input character sequences, based on patterns learned from training data, including but not limited to large language models.

The term “analysis result” refers to information output by a generative AI model in response to a prompt sentence, including at least a list of procedures, a list of documents required for the procedures, and document drafts for the documents.

The term “internal procedure type” refers to a classification code or category used by the system to represent a specific kind of procedure in a standardized internal representation, independent of the wording used in an analysis result.

The term “document draft” refers to a text body or content outline generated by a generative AI model or by the processor, which is intended to be incorporated into an electronic document corresponding to a procedure.

The term “template data” refers to data representing a document layout including predetermined regions or placeholders that are configured to be replaced with dynamic values such as party attributes, property attributes, and document drafts.

The term “electronic document data” refers to machine-readable data representing a document in an electronic format, generated on the basis of template data and inserted values, and suitable for display, storage, or transmission.

The term “file in a viewing format” refers to a file format configured to be rendered by a general-purpose viewer application, including, for example, a portable document file format or a markup-based display format.

The term “external organization” refers to an entity outside the system that receives electronic document data for processing a property succession, such as a public authority, a financial institution, or a legal organization.

The term “destination information” refers to data specifying an address or endpoint to which electronic document data is to be transmitted, including, for example, an electronic mail address, a network endpoint, or an identifier for an application interface.

The term “communication network” refers to an infrastructure that enables transmission of data between devices, including at least one of a local network, a wide-area network, or a public communication network.

The term “progress state” refers to data representing a status of a procedure or a set of procedures within a property succession workflow, including, for example, not-started, in-preparation, submitted, under-review, and completed.

The term “display information” refers to data that, when processed by a terminal, causes presentation of visual or other sensory output indicating at least a progress status of procedures and availability of electronic document data.

The term “additional input” refers to supplementary succession-related information provided after an initial input, including newly discovered parties, property, or procedural conditions.

The term “correction input” refers to updated succession-related information that modifies or replaces previously stored information due to correction of errors or changes in circumstances.

The term “re-analysis” refers to processing by a generative AI model and associated logic, performed again using updated prompt sentences including additional input or correction input, to generate an updated analysis result.

The term “end-of-life support” refers to assistance functions implemented by a server for arranging operations associated with a person's death, including, for example, handling of user information in online services and notifications of death.

The term “social network service” refers to a network-based platform that manages user accounts and enables distribution or sharing of information among users or groups of users.

The term “management apparatus of the social network service” refers to one or more computing resources that control data storage, account management, and content distribution for a social network service, and that provide an interface for receiving instructions regarding user information processing.

The term “guidance information” refers to information prepared for presentation to a user or to recipients on a social network service, indicating recommended actions, status explanations, or procedural steps related to end-of-life or property succession.

The term “notification information” refers to information configured to notify a recipient of an event related to end-of-life, such as a death notice or account termination notice, which is generated or formatted for use in a social network service.

In one embodiment, a server operates as an information processing apparatus configured to support property succession procedures using a generative AI model and structured prompt sentences. The server is implemented on a computing platform including one or more processor cores, a main memory, a non-transitory storage device, and a network interface. The server executes an operating system, a database management system, an application server framework, and a generative AI client library.

The server uses, as one example configuration, a general-purpose cloud environment in which a virtual machine instance executes a server-side application. The server accesses a relational database system, such as a relational database engine running on a remote storage service, and accesses a file storage service for persistent storage of electronic document data and template data. The server further uses a generative AI inference service implementing a large language model. The generative AI model is, in one embodiment, a transformer-based neural network comprising multiple self-attention layers, feed-forward layers, and layer normalization components, trained on large-scale text corpora.

The server stores succession-related information in a structured manner. The server defines, in the storage device, tables or records including at least: a party table for transferor and successor attributes (such as names, identifiers, relationship codes, and contact attributes), a property table for asset attributes (such as property type, valuation, location, and classification codes), a procedure table for internal procedure types, a document table for document metadata, a case table that links parties, properties, procedures, and documents, and a prompt log table that records prompt sentences and corresponding generative AI outputs. The server stores each piece of attribute information in normalized form, for example by assigning integer codes for relationship types and property types, and by storing temporal attributes in machine-parseable formats.

The server uses a natural language processing module to process natural language text received from a terminal. The server implements tokenization, part-of-speech tagging, named entity recognition, and dependency parsing using a language processing library running on the processor. The server maps identified named entities to internal identifiers and table fields. For example, the server maps a date expression in the natural language text to a standardized date field for the transferor's date of death. The server thereby converts heterogeneous, free-form text input into a combination of structured feature vectors and symbolic records that can be used to construct a prompt sentence and to drive downstream document generation.

The server uses a generative AI client module to interact with the generative AI model. The server constructs a prompt sentence as a single text sequence that is logically divided into portions including a role instruction portion, a task instruction portion, a case summary portion, and an output format instruction portion. The server generates these portions by concatenating template strings and field values retrieved from the storage device. In one embodiment, the server defines and stores prompt templates, and uses string substitution operations to embed case-specific attributes into the templates.

The server uses a transformer-based generative AI model as the generative AI model. The generative AI model includes multiple encoder-decoder blocks or decoder-only blocks, each block including a multi-head self-attention module and a feed-forward neural network. Each attention module computes attention scores over token embeddings using learned weight matrices, and each feed-forward network applies non-linear activation functions such as rectified linear units or Gaussian error linear units. The generative AI model is trained using a cross-entropy loss function that measures the difference between predicted token distributions and target tokens in training sequences. During training, the generative AI model updates its weight parameters by gradient descent with an optimizer such as Adam, using mini-batches of training data. The generative AI model learns to represent complex patterns in succession-related text and legal/administrative procedures as latent feature representations in high-dimensional vector spaces.

The server uses the generative AI model not merely to replace human text drafting, but as a programmable transformation component that converts prompt sentences into structured analysis results. The server configures the output format instruction portion of the prompt sentence to require output that adheres to a machine-interpretable structure, such as multiple labeled sections or key-value pairs that can be deterministically parsed. This configuration allows the server to reduce post-processing complexity and minimize parsing errors, thereby improving computational efficiency.

The server improves computer technology by combining the following technical features. First, the server automatically generates the prompt sentence using a predefined internal representation of candidate procedures, party attributes, and property attributes. This automated prompt generation reduces the size and complexity of the data transmitted from the terminal to the generative AI model, thereby reducing communication load. Second, the server enforces a deterministic mapping between prompt portions and internal data structures, which allows the server to programmatically validate and reconcile generative outputs against reference information stored in the database. This improves data integrity and facilitates efficient, incremental updates when new information arrives.

The server uses the generative AI model in conjunction with a verification module that compares model outputs with internal procedure definitions. The server computes similarity scores between textual labels in the analysis result and internal procedure names using vector representations (for example, using word or sentence embeddings) and selects the internal procedure type that exceeds a similarity threshold. The server thereby implements a rule-based and threshold-based mapping algorithm that converts unconstrained generative text into constrained internal codes. This algorithm reduces errors caused by variations in wording and increases the robustness of the system when faced with diverse inputs.

The server performs specific data processing operations to generate electronic document data. The server retrieves template data corresponding to each document type. The server defines for each template data structure a set of placeholders mapped to database fields or sections of the document draft. The server performs placeholder replacement by scanning the template data for marker tokens, retrieving corresponding values from the storage device or the analysis result, and writing these values into the template. This templating process is applied to structured document layouts, reducing manual formatting operations and ensuring consistent document structure. The server then uses a document generator module to convert filled templates into a viewing format file, such as a portable document file, by executing layout rendering algorithms and text encoding routines.

The server uses communication protocols to transmit electronic document data to external organizations. The server formats messages that include the electronic document data and metadata, such as procedure type codes and case identifiers. The server may use a mail transfer protocol or a web service protocol, such as an HTTP-based application programming interface, to deliver the data. The server receives acknowledgment responses or status codes and updates progress states in the storage device accordingly. This closed-loop communication, in which the server both transmits documents and receives machine-readable status information, allows the server to accurately track the lifecycle of each procedure and to present up-to-date status to the terminal.

The server reduces computational overhead by reusing intermediate analysis results. For example, when the user provides correction input, the server identifies which attributes or properties have changed and determines whether the change affects all procedures or only a subset. The server then regenerates only the relevant portions of the prompt sentence and requests from the generative AI model only the portions of the analysis that require updating, such as revised document drafts or additional procedures. This selective re-analysis reduces the number of tokens processed by the generative AI model and shortens processing time, thereby improving responsiveness.

The server uses a multi-module architecture including at least: an input reception module, a natural language processing module, a prompt generation module, a generative AI interaction module, an analysis mapping module, a document generation module, a communication module, and a progress management module. Each module exchanges data through defined data structures, such as case objects that aggregate references to parties, properties, procedures, documents, and prompts. This modular structure allows alternative implementations. For example, the server may replace the relational database system with a document-oriented database, while preserving the logical mapping between defined entities and the prompt generation process. The server may replace the transformer-based generative AI model with another generative model that supports token-based sequence generation and structured instructions, as long as the model can interpret the defined prompt portions and produce structured analysis results.

The server uses the generative AI model in a way that departs from conventional human workflows. Rather than simply drafting a textual document, the generative AI model produces content according to a non-traditional, machine-centric rule set defined by the output format instruction portion. The server instructs the generative AI model to produce clearly separated sections, such as “PROCEDURES:”, “DOCUMENTS:”, and “DRAFTS:”, and further instructs that each item include identifiers that can be mapped to internal codes. This non-conventional format is not naturally produced by a human without explicit instructions and is specifically designed to enhance machine interpretability, thus providing a technical effect on the computer system.

The server improves accuracy by training or fine-tuning the generative AI model on domain-specific data. In one embodiment, the server uses a training pipeline in which a large-scale text corpus containing succession-related texts is pre-processed into token sequences. The server uses a loss function that penalizes incorrect procedure identification and missing document fields more heavily than minor wording differences, thereby biasing the model toward accurate structural outputs. The server updates model weights using stochastic gradient descent or an adaptive variant, adjusting learning rates and regularization parameters to avoid overfitting. This training method allows the model to generalize better to previously unseen succession cases while maintaining high precision in procedure and document identification.

The server may implement data augmentation techniques during training, such as paraphrasing natural language descriptions, randomly masking attribute values, and generating synthetic succession cases with controlled variations. These techniques expand the distribution of input prompts and improve the model's robustness when processing diverse and noisy user inputs. As a result, the system exhibits lower error rates and reduces the need for manual correction by users. The server also supports integration with social network services as part of an end-of-life support function. The server uses the same prompt generation mechanism to construct prompt sentences that incorporate both the internal progress state of succession procedures and social network account attributes. The server instructs the generative AI model to generate guidance information and notification messages that conform to policies or message length constraints of the social network service. The server then transmits the generated content to a management apparatus of the social network service via a programmatic interface. In this way, the server uses the generative AI model to coordinate internal workflow states and external communication channels, which would be difficult to manage consistently by human operators, especially at scale.

The terminal operates as a client apparatus that interacts with the server. The terminal executes a browser or a dedicated application, renders user interface elements, and sends user inputs to the server over a communication network. The terminal displays, based on display information from the server, the list of procedures, document drafts, and progress states. The terminal allows the user to review generated document text, to approve or request changes, and to provide additional or correction input. The terminal does not implement core analysis algorithms; instead, it delegates analysis and document generation to the server, thereby reducing processing requirements on the terminal and enabling centralized control over data consistency. The user interacts with the terminal by entering natural language descriptions and structured form data. The user may, for example, input a prompt sentence that reflects a real succession scenario.

In one example, the user enters:
“My father died on Jan. 5, 2026. He owned a house worth about 40 million yen and bank savings of about 10 million yen. I am the only child. Please tell me all necessary procedures and generate the required documents, including an agreement on division of estate and inheritance tax documents.”

The server receives this input, parses it, converts it into structured attributes, and constructs a prompt sentence for the generative AI model. In one example, the server generates a prompt sentence as follows:
“You are an expert on inheritance procedures in the relevant jurisdiction. A user entered the following description: ‘My father died on 2026-01-05. He owned a house worth about 40 million yen and bank savings of about 10 million yen. I am the only child.’ Based on this information, list all required legal and administrative procedures for property succession, list all required documents, and generate draft texts for an agreement on division of estate and for inheritance tax-related documents. Provide your answer in clearly separated sections labeled PROCEDURES, DOCUMENTS, and DRAFTS, and include, for each item, a concise identifier that can be used as a key.”

In another example, when the user later adds information, the user enters:
“The house is in Tokyo, and there are no other heirs. Please update the procedures and documents accordingly.”

The server generates an updated prompt sentence such as:
“Update the previous analysis with this additional information: ‘The house is located in Tokyo, and there are no other heirs.’ Adjust the list of procedures and document drafts accordingly. In your output, clearly indicate which procedures or documents have been added, removed, or modified compared to the previous analysis, and maintain the same section labels and identifiers.”

The server thereby ensures that the generative AI model's outputs remain synchronized with the stored internal representation, and that incremental changes are propagated efficiently. The described embodiments are illustrative, and the server may adopt various alternatives. For example, the server may implement different neural network architectures, such as recurrent networks with attention mechanisms or hybrid models that combine rule-based components and neural components. The server may partition the generative AI model into multiple specialized sub-models, one for procedure identification and another for document drafting, and may orchestrate calls to these models using a control policy based on case complexity. The server may also implement caching mechanisms for commonly occurring succession patterns, allowing reuse of previously generated procedures and document drafts without re-invoking the generative AI model, thereby further reducing computational load and improving latency.

By implementing these techniques, the server improves the functioning of the computer system itself. The system performs structured prompt generation and constrained interpretation of generative outputs, which reduces ambiguity and enhances processing speed and accuracy. The system utilizes specialized internal data structures and deterministic mapping algorithms to integrate generative model outputs into a transactional workflow engine. As a result, the system provides technical effects such as reduced processing time, lower error rates, improved data consistency, and reduced communication overhead, beyond mere automation of human mental processes.

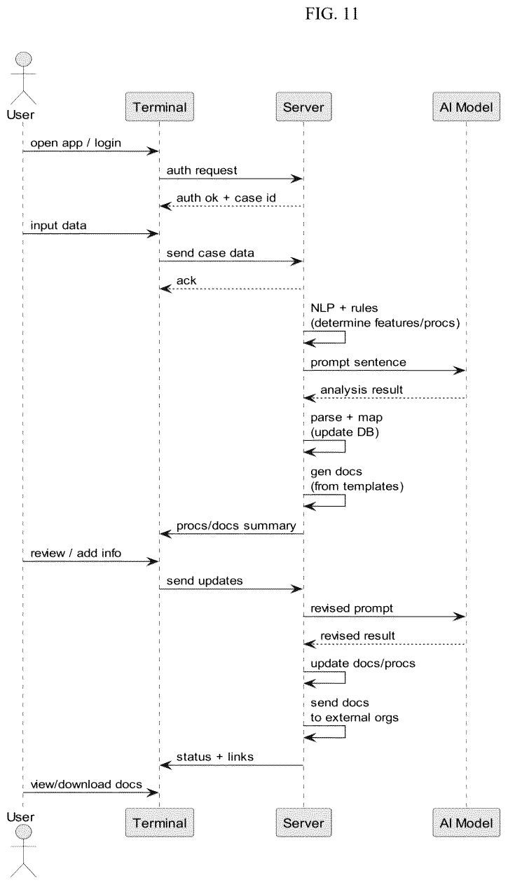

The following describes the processing flow using FIG. 11.

### Step 1:

User operates the terminal to access the succession support application.

User launches a browser or dedicated application on the terminal and inputs a uniform resource locator or selects an application icon. The terminal sends an HTTPS request to the server to obtain an initial screen. As input, the terminal provides device identification information and session information, and as output, the terminal receives markup data, style data, and script data from the server. The terminal renders these data into a login or start screen for the user.

### Step 2:

User authenticates and selects creation of a new succession case.

User inputs authentication information such as an identifier and a secret key into the terminal and selects a menu item for starting a new succession case. The terminal sends the authentication information and a request type to the server. The server verifies the authentication information against account data stored in a storage device and, when valid, generates a new case identifier and initializes records in a case table. The server outputs a response containing the case identifier and initial case metadata, and the terminal stores this identifier for subsequent requests.

### Step 3:

User inputs natural language description and structured attributes regarding succession.

User types a free-text description of the succession situation into a text field and fills in structured fields such as names, dates, and asset categories on the terminal. The terminal converts the inputs into a structured message, for example a set of key-value pairs, and sends them to the server together with the case identifier. As input, the server receives mixed-format data including text strings and structured attributes; as output, the server writes these data into party records, property records, and a case description record in the storage device.

### Step 4:

Server normalizes and validates received succession-related information.

Server retrieves the raw input data for the case from the storage device. As input, the server uses the text description, attribute values, and predefined validation rules stored in configuration data. The server performs data normalization, such as converting date strings to standard date formats and mapping relationship texts to relationship codes, and checks the presence of mandatory fields. The server outputs normalized records and a validation status, and updates the storage device to reflect normalized values and any detected missing information flags.

### Step 5:

Server applies natural language processing to extract structured features.

Server inputs the natural language description for the case and uses a natural language processing module to tokenize sentences, detect named entities (such as person names, places, and monetary values), and identify syntactic roles. The server maps entities to candidate attributes (for example, mapping “father” to a transferor role) and calculates semantic similarity scores between extracted phrases and internal property and procedure labels. As output, the server produces a set of structured features, including attribute-value pairs and candidate procedure labels with confidence scores, and stores these features in an analysis feature table linked to the case.

### Step 6:

Server determines candidate procedures based on extracted features and internal rules.

Server inputs the feature set and internal rule definitions that map conditions to procedure types. The server evaluates rule predicates, such as asset thresholds or number of successors, against the features. The server then selects candidate procedures whose conditions are satisfied and assigns each candidate an internal procedure type code and a confidence score. As output, the server generates a list of candidate procedure records and writes them into the procedure table associated with the case.

### Step 7:

Server constructs a structured prompt sentence for the generative AI model.

Server inputs the normalized case attributes, the natural language description, and the list of candidate procedures. The server accesses stored prompt templates that contain placeholders for role instructions, task instructions, case summary text, and output format instructions. The server performs string substitution operations to insert current case values and candidate procedure labels into the template. The resulting prompt sentence is a single text sequence segmented logically into portions. As output, the server stores the constructed prompt sentence in a prompt log record and passes it to a generative AI interaction module.

### Step 8:

Server sends the prompt sentence to the generative AI model and receives an analysis result.

Server uses the generative AI interaction module to input the prompt sentence to a generative AI model endpoint. As input, the server provides the prompt sentence, model selection parameters, and decoding parameters such as maximum token count and temperature. The generative AI model processes the sequence using its layers of attention and feed-forward transformations to compute token probabilities and generate an output sequence that encodes procedure lists, document lists, and document drafts. As output, the server receives the generated text, which is structured according to the output format instructions, and records the text as an analysis result associated with the prompt log entry.

### Step 9:

Server parses the generative AI model output into structured internal data.

Server inputs the analysis result text and a parsing specification that defines section labels and item formats. The server scans the text to locate labeled sections, separates the text into “procedures,” “documents,” and “drafts,” and further splits each section into items. The server uses pattern matching and delimiter detection to identify identifiers, names, and body texts for each item. As output, the server generates structured objects representing procedures, documents, and document drafts, and inserts these objects into corresponding tables in the storage device, linking them to the case and to internal procedure type codes.

### Step 10:

Server maps external procedure and document labels to internal codes.

Server inputs the parsed procedure and document labels and internal reference tables that define standardized procedure types and document types. The server computes similarity metrics, such as cosine similarity between vector embeddings of labels, and applies threshold-based selection to map each label to an internal code. The server resolves conflicts by preferring mappings with higher similarity scores and consistent context. As output, the server updates the procedure and document records with matched internal codes and records any items that could not be matched for later review or refinement.

### Step 11:

Server generates human-readable guidance summaries for the case.

Server inputs the mapped procedure and document records and predefined summary templates. The server aggregates procedure names, deadlines, and required documents, and formats them into concise paragraphs and bullet lists using text concatenation algorithms. The server constructs a guidance summary that explains in natural language the overall sequence of steps for the user. As output, the server creates a guidance record containing the formatted text and transmits the summary to the terminal in a response message for display.

### Step 12:

Terminal displays procedures, required documents, and drafts to the user.

Terminal receives guidance text, structured lists of procedures and documents, and preview portions of document drafts from the server. The terminal inputs these data into a user interface rendering module, which builds lists, headings, and text areas using graphical components. The terminal visually arranges the procedures in sequence and shows for each document a preview including the first lines of the draft text. As output, the terminal presents an interactive screen that allows the user to read the guidance, scroll through drafts, and select items for further details.

### Step 13:

User reviews outputs and provides additional or correction input.

User examines the guidance and draft documents displayed on the terminal. When discrepancies or omissions are found, the user inputs additional information or corrections into dedicated fields, such as clarifying an asset's location or confirming the number of successors. The terminal packages the new information together with indicators of which attributes are being changed and sends this package to the server. As input, the server receives the updated attributes and modification flags; as output, the server updates corresponding records in the storage device and marks related procedures and documents as requiring re-analysis.

### Step 14:

Server regenerates or refines the prompt sentence and requests re-analysis.

Server identifies which sections of the case have been modified by inspecting modification flags. The server inputs the updated attributes and previous prompt sentence and generates a revised prompt sentence that includes an update instruction portion. The server composes text that references the previous analysis and explains the new facts. The revised prompt sentence is stored and then sent to the generative AI model. As output, the server receives a new analysis result focused on affected procedures and documents and records the result in the prompt log and analysis tables.

### Step 15:

Server updates document drafts and procedure records based on re-analysis.

Server inputs the revised analysis result and the existing procedure and document records for the case. The server compares identifiers and content, determines which procedures or documents have been added, removed, or modified, and updates records accordingly. The server overwrites draft texts for modified documents, inserts new document records when necessary, and marks obsolete documents as inactive. As output, the server produces an updated set of procedure and document records that reflect the latest case state.

### Step 16:

Server generates electronic document data from templates and drafts.

Server retrieves template data corresponding to each active document type and the associated document drafts and attribute values. The server inputs the template, a mapping of placeholders to values, and the draft text. The server scans the template for placeholder tokens, replaces each token with the appropriate value, and merges the draft text into designated sections. The server then calls a document conversion module to transform the filled template into an electronic document file in a viewing format. As output, the server stores the generated file in a file storage system and writes file location references into the document records.

### Step 17:

Server determines external destinations and transmits electronic documents.

Server inputs the procedure type codes and configuration data that map procedure types to external organizations and their communication endpoints. The server selects the appropriate destination for each document, constructs message payloads that include the electronic document file and metadata, and sends the payloads via a mail protocol or web service protocol over the communication network. The server receives response status codes or acknowledgments. As output, the server records the transmission results and updates progress states of the corresponding procedures, such as changing states from “in preparation” to “submitted.”

### Step 18:

Server notifies terminal of updated progress states and document availability.

Server inputs updated progress states and document file locations associated with the case. The server assembles a status message that includes procedure states, timestamps, and links or identifiers for generated documents. The server sends this message to the terminal. As output, the terminal receives the status message and updates its user interface to show new states, such as marking procedures as completed or under review, and enabling buttons for viewing or downloading the corresponding files.

### Step 19:

Terminal provides access to generated electronic documents for review and storage.

Terminal uses the received document location references to request individual files when the user selects a view or download action. The terminal inputs a selected document identifier and sends a retrieval request to the server or file storage system. The terminal receives the file as a data stream and, as output, displays the document in a viewer component or saves it to local storage, allowing the user to visually confirm the contents and archive the file if desired.

### Step 20:

Server optionally prepares end-of-life support messages for social network services.

Server inputs the current succession-related information, including progress states and any social network account attributes associated with the user. The server constructs a specialized prompt sentence that instructs the generative AI model to generate end-of-life guidance or notification messages suitable for social network services. The server sends this prompt sentence to the generative AI model and receives text messages as output. The server then formats these messages according to social network service requirements and transmits them to a management apparatus of the social network service, thereby linking the internal workflow state to external account handling and notifications.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented systems for handling inheritance and succession procedures primarily function as static form-filling tools or simple checklists. Such systems generally require users to manually interpret legal and administrative requirements, determine which procedures and payments are applicable, and calculate fee amounts by themselves or with significant human professional support. As a result, server-side processing is largely limited to storing and displaying user-entered data, without performing substantive analysis, automated calculation of required payments, or end-to-end execution of electronic transactions. This leads to several technical problems in the operation of information processing devices.

First, existing systems do not effectively use machine processing resources to transform unstructured, natural language user input into structured, machine-readable payment plans. When a user inputs inheritance-related information in free-text form, conventional servers either store the text as-is or perform only rudimentary keyword matching. The server is not configured to perform multi-stage processing that includes natural language analysis, generation of a constrained prompt for a generative AI model, parsing of model output into a defined machine-readable format, and further transformation into data structures directly usable for transaction processing. Consequently, the server must rely on external human intervention or custom-coded rule engines, which are difficult to maintain and scale and do not adapt well to diverse factual scenarios.

Second, conventional architectures lack a unified processing pipeline that tightly couples (i) server-side natural language analysis, (ii) prompt sentence construction and interaction with a generative AI model, (iii) automatic generation and normalization of payment plan information, and (iv) execution of electronic payment processing through a transaction processing apparatus. Because these functions are not integrated as coordinated server-side processing stages, technical inefficiencies occur: multiple systems must be stitched together via manual data re-entry or ad hoc scripts, error handling is fragmented, and data consistency between user input, calculated plans, and executed payments is not guaranteed. This fragmentation increases computational overhead, promotes inconsistent internal representations of data across subsystems, and complicates secure, traceable transaction processing.

Third, many existing solutions do not provide a mechanism by which a server can specify, at a technical level, output constraints to a generative AI model and then verify and normalize the model's response into well-defined structured data. Without such mechanism, the server receives unstructured text that is difficult for downstream components to consume. Parsing such text requires heuristics that are brittle and resource-intensive. The absence of reliable machine-readable output generation directly from the model prevents robust automation of payment calculation, integrated storage, and direct linkage to electronic payment execution. As a result, the computational workflow is error-prone and unsuitable for high-assurance transaction processing.

Fourth, conventional systems often treat visualization of inheritance procedures and payment items as a pure user interface concern on the client side, instead of a server-coordinated data transformation step. Because the server does not generate normalized, display-ready representations of the payment plan, terminals must implement additional logic to interpret and restructure heterogeneous data. This duplication of logic across terminals leads to increased processing load on each terminal, inconsistent user experiences, and difficulty maintaining correctness when the underlying procedure or payment logic changes on the server.

Therefore, there is a need for an improved computer-implemented technique in which a server is configured to (i) receive succession-related information, including unstructured natural language input, (ii) perform structured analysis using natural language processing, (iii) automatically construct and transmit a prompt sentence with explicit output constraints to a generative AI model, (iv) obtain machine-readable payment plan information, (v) normalize and store this information in association with user-specific identifiers, (vi) generate display data for visualization on terminals, and (vii) directly trigger and manage electronic payment processing through a transaction processing apparatus. By technically integrating these operations within a single server-side processing pipeline, the system can improve computational efficiency, data consistency, automation level, and reliability of electronic transactions related to succession procedures.

The specific processing by the specific processing unit 290 of the data processing device 12 in Application Example 1 is realized by the following means.

The present invention provides a server comprising a processor configured to receive succession-related information from a transferor and a successor via a communication interface, analyze the succession-related information by using a natural language processing component to convert at least a portion of the succession-related information from unstructured text into structured internal data, construct, based on a result of the analyzing, a prompt sentence including the structured internal data and constraint conditions specifying an output format to be input to a generative information processing model, transmit the prompt sentence to the generative information processing model via a model access interface, obtain, from the generative information processing model, payment plan information in a machine-readable format including payment items and payment amounts required for a succession procedure, normalize the payment plan information into structured data stored in a storage device in association with identification information of the transferor and the successor, convert at least part of the structured data into display data for a display terminal so as to visualize procedure contents and payment contents related to the succession, and execute, based on the structured data, payment processing by transmitting an electronic payment request to a transaction processing apparatus via a financial transaction interface and by receiving a payment result from the transaction processing apparatus. This enables the server to implement, as an integrated, computer-implemented processing pipeline, automated analysis of succession-related information, constrained interaction with a generative AI model using prompt sentences, reliable generation and normalization of machine-readable payment plan data, centralized management and visualization of procedure and payment status, and direct initiation and control of electronic payment transactions, thereby improving computational efficiency, data consistency, and automation in succession-related processing performed by information processing devices.

The term “processor” refers to one or more hardware computing elements, such as a central processing unit, a graphics processing unit, or a combination thereof, configured to execute machine-readable instructions to perform data processing operations described in the present disclosure.

The term “succession-related information” refers to information concerning a transfer of property or rights upon death or other succession events, including but not limited to information about assets, liabilities, heirs, relationships, desired procedures, and free-text descriptions provided by a user.

The term “transferor” refers to a person or entity from whom property, rights, or obligations are to be transferred in a succession procedure.

The term “successor” refers to a person or entity that receives property, rights, or obligations from a transferor in a succession procedure.

The term “communication interface” refers to a hardware and software combination that enables data exchange between the server and one or more external devices or systems, including but not limited to network interface controllers, communication protocols, and associated drivers.

The term “natural language processing component” refers to a software module or collection of software modules that analyze and transform natural language text into one or more structured representations, using techniques such as tokenization, parsing, semantic analysis, or entity extraction.

The term “unstructured text” refers to information expressed in natural language without a predefined machine-readable schema, such as free-text input entered by a user.

The term “structured internal data” refers to data organized according to a defined schema, such as key-value pairs, lists, or records, enabling deterministic processing by computer programs.

The term “prompt sentence” refers to a sequence of characters or tokens including instructions, input data, and optional constraints, which is transmitted from the server to a generative information processing model to cause the model to produce a response.

The term “generative information processing model” refers to a trained computational model, such as a generative artificial intelligence model, that produces output data, including text or structured data, in response to input data and prompt sentences.

The term “model access interface” refers to a hardware and software combination that enables the processor to send requests to and receive responses from a generative information processing model, including but not limited to application programming interfaces, network communication modules, and message formatting logic.

The term “payment plan information” refers to information that specifies one or more payment items and corresponding payment amounts required for a succession procedure, optionally including descriptions, notes, and scheduling information.

The term “payment item” refers to an individual financial obligation associated with a succession procedure, such as a registration fee, tax amount, or administrative charge.

The term “payment amount” refers to a numerical value indicating a monetary quantity associated with a payment item.

The term “machine-readable format” refers to a representation of data that can be parsed and processed by a computer program according to a defined syntax, such as a structured text format, a markup language, or a serialized data structure.

The term “structured data” refers to data that conforms to a predefined schema, such as a set of fields with defined data types and relationships, enabling consistent storage, retrieval, and processing by software components.

The term “storage device” refers to one or more hardware components configured to store data persistently or semi-persistently, such as solid-state drives, magnetic disks, or non-volatile memory, possibly managed by a database management system.

The term “identification information” refers to data that uniquely or quasi-uniquely distinguishes a user, an account, a transaction, or a request, such as an identifier, an account number, or a session token.

The term “display data” refers to data formatted or arranged so that a terminal can render a human-perceivable representation, including but not limited to text, numeric values, labels, and layout information.

The term “display terminal” refers to an information processing device having at least a display unit and a communication function, such as a smartphone, tablet, or personal computer, configured to receive display data from the server and present the data to a user.

The term “procedure contents” refers to information that describes steps, requirements, documents, or statuses associated with a succession procedure.

The term “payment contents” refers to information that describes payment items, payment amounts, and related conditions associated with a succession procedure.

The term “financial transaction interface” refers to a hardware and software combination that enables the server to communicate with a transaction processing apparatus for the purpose of initiating, monitoring, or completing financial transactions.

The term “electronic payment request” refers to a data message transmitted from the server to a transaction processing apparatus, specifying at least a payment amount and payment-related parameters for executing a financial transaction.

The term “transaction processing apparatus” refers to a computing system operated by or on behalf of a financial service provider or similar entity, which is configured to process electronic payment requests and return transaction results.

The term “payment processing” refers to a series of operations performed by the server and the transaction processing apparatus to execute a financial transaction, including authorization, capture, settlement, or failure handling.

The term “payment result” refers to information indicating an outcome of payment processing, such as success, failure, or pending status, and optionally including identifiers, timestamps, and error codes.

In one embodiment, a server implements the claimed system as a network-accessible inheritance support platform. The server comprises at least one physical processor, a main memory, a non-volatile storage device, a network interface controller, and executable software modules. The server executes an operating system such as a general-purpose server operating system and middleware including a web application framework, a database management system, and a communication library for accessing a generative AI model. The server communicates with one or more terminals operated by a user via a packet-switched network.

The server executes an application program that is logically divided into multiple modules, including a communication module, an input analysis module, a natural language processing module, a prompt generation module, a generative-model interaction module, a payment plan computation module, a data normalization and storage module, a display data generation module, and a transaction processing module. Each module is implemented as machine-executable instructions stored in the storage device and loaded into the main memory for execution by the processor.

The terminal is, for example, a smartphone, a tablet computer, or a personal computer. The terminal comprises a display, an input device, a network interface, and a processor executing client-side software. In one embodiment, the terminal executes a browser that runs a client application implemented using a component-based user interface framework. Alternatively, the terminal executes a native application using a similar component-based architecture. The terminal transmits succession-related information, such as natural language descriptions and numeric values, to the server, and the terminal receives and renders display data from the server. The user operates the terminal to input succession-related information. The user enters, in natural language text, information regarding assets, relationships, and intentions, and further selects or inputs structured attributes such as estimated property values and number of successors. The terminal converts this input into a structured request and transmits the request to the server through the communication interface.

The server receives the succession-related information via the communication module and stores the raw request in the storage device in association with identification information. The server then performs natural language analysis using the natural language processing module. In one embodiment, the natural language processing module uses a tokenization algorithm that segments input text into subword units, a part-of-speech tagger, and a named-entity recognizer to extract entities such as asset types, approximate values, and kinship relations. The server represents the extracted features as a feature vector, for example a fixed-dimensional numeric vector where each dimension corresponds to a specific token, entity, or semantic role. The server thereby converts unstructured text into structured internal data suitable for deterministic processing. The server uses the structured internal data to generate a prompt sentence for a generative AI model. The server constructs the prompt sentence as a concatenation of instruction segments, constraint segments, and data segments. For example, the server generates a prompt sentence such as:
“You are an assistant that calculates all payments required for inheritance procedures in a given jurisdiction. Consider registration fees, estimated inheritance tax, and typical administrative costs. Based on the following information, list each required payment item and its estimated amount, and provide a short explanation for each item. Output the result as a list with clear labels. User information: I want to handle the inheritance procedure for my father's estate. There is one house worth about 30 million yen and deposits of 5 million yen. The heirs are me and my younger sister.”

In another embodiment, the server includes explicit output format constraints in the prompt sentence, for example:
“You are an assistant that calculates all payments required for inheritance procedures. Using the following input, output a payment plan with items numbered (1), (2), (3), each line containing ‘item name: amount in yen—explanation’. Input: I want to handle the inheritance procedure for my father's estate. There is one house worth about 30 million yen and deposits of 5 million yen. The heirs are me and my younger sister.”

The server structures the prompt generation as a deterministic transformation: the server maps each field of the structured internal data (such as estate value, number of heirs, and relation type) to a corresponding textual fragment. The server concatenates the fragments in a predefined order to form the final prompt sentence. This specific prompt generation process reduces ambiguity in the generative AI model output and thus improves the precision and stability of the downstream computation of payment plans.

The server transmits the prompt sentence to a generative AI model hosted on one or more remote computing devices. The generative AI model is, in one embodiment, a neural-network-based language model comprising multiple transformer layers. Each transformer layer includes a multi-head self-attention mechanism and position-wise feed-forward networks. The model parameters, including attention weights and feed-forward weights, are real-valued parameters learned during pre-training and, optionally, fine-tuning. The server communicates with this generative AI model via a model access interface that encapsulates network communication protocols, authentication, request formatting, and response parsing.

The server uses the generative-model interaction module to send a request containing at least the prompt sentence and configuration parameters such as maximum token count and sampling temperature. The server specifies, as a parameter, a low sampling temperature to reduce randomness and to obtain deterministic, reproducible payment plan proposals. The server also specifies a maximum output length to constrain the computational load and communication bandwidth. The server receives a response from the generative AI model containing generated text that is conditioned on the prompt sentence and the model's internal parameters.

The generative AI model internally processes the prompt by embedding tokens into a high-dimensional vector space, computing self-attention scores between tokens, and propagating representations through multiple transformer layers. During training (performed prior to deployment), the generative AI model minimizes a loss function such as cross-entropy over next-token predictions, and the model uses gradient-based optimization algorithms such as Adam to update the weights. The model may also be fine-tuned on domain-specific texts related to inheritance and financial procedures to improve domain accuracy. These training details enable the server to rely on the model as a computation engine that can generate contextually appropriate and structurally rich text in response to carefully crafted prompt sentences.

The server parses the output of the generative AI model using the payment plan computation module. The server applies a pattern-matching algorithm and, in one embodiment, a deterministic finite automaton that recognizes numbered lines and colon-separated fields. For each line, the server extracts an item name, an amount, and an explanation. The server converts the amount into a numeric representation after removing formatting symbols such as commas and currency labels. The server thereby generates a structured representation of the payment plan, for example as an array of records, each containing fields for a payment item identifier, an item name, an amount, and a description. The server further computes a total amount by summing all item amounts using integer arithmetic, and the server stores the total amount as part of the structured data.

The server stores the structured data, including the payment items, amounts, and related metadata, into the storage device using the data normalization and storage module. The storage device is managed by a database management system, and the server uses a schema that associates each payment plan with a unique request identifier and user identifier. The schema includes tables or collections representing succession cases, payment items, and payment transactions. This normalized data model reduces redundancy and facilitates consistent retrieval and update operations, thereby improving data management efficiency.

The server converts the structured data into display data for the terminal using the display data generation module. The server prepares a representation where each payment item is associated with human-readable labels, formatted numeric values, and layout hints such as ordering and grouping. The server, for example, formats amounts with thousands separators and attaches textual currency labels. The server may also attach status flags representing whether each item has been paid or is pending. By generating display-ready data on the server side, the server reduces computation required by the terminal and ensures that different terminals present consistent information.

The terminal receives the display data and renders lists or tables of payment items and totals. The terminal applies minimal additional formatting and transformation, thereby offloading the main computation to the server. The user can then review the visualization of procedure contents and payment contents, including the breakdown of required payments.

The server also implements the transaction processing module to perform electronic payment processing. The server uses a financial transaction interface to communicate with a transaction processing apparatus, such as a payment gateway system. The server constructs an electronic payment request that includes, for each selected payment item, the amount, a currency code, and identifiers for the user and the succession case. The server transmits this payment request to the transaction processing apparatus using a secure network protocol. The transaction processing apparatus performs authorization and settlement operations and returns a transaction result. The server receives the result, updates the stored structured data to reflect payment status, and generates updated display data for the terminal.

The server thereby realizes an integrated processing pipeline that transforms unstructured natural language input regarding succession into structured payment plans and further into executed electronic transactions. The pipeline is not limited to a mere automation of human mental steps. The server uses specific data structures, including feature vectors, structured internal representations, and normalized database tables, and uses precise algorithmic steps, including language-token processing, prompt composition, deterministic parsing, and integer-based aggregation, that improve computational behavior.

The system improves processing speed by eliminating manual interpretation and by using fixed algorithmic pathways that reduce the need for iterative user queries. The server reduces communication load by generating concise, machine-consumable prompts and by constraining the response length via model parameters. The system improves accuracy and reduces errors because the server systematically normalizes and verifies the generative output, including checking consistency between total amounts and sum of individual items, and because the server applies deterministic parsing rules to the model output rather than relying on ad hoc user interpretation.

The server can, in another embodiment, use an alternative generative AI model or a locally hosted model. In this variant, the server deploys a transformer-based neural network on its own hardware. The server then uses a local inference engine that performs matrix multiplications optimized by vectorized instructions or hardware accelerators. The internal architecture remains similar: the model uses stacked self-attention layers and learned embeddings, and the server uses prompt sentences that encode both the user's succession information and explicit output constraints. This embodiment can further reduce network latency and enhance privacy for sensitive succession-related information.

In yet another embodiment, the server combines the generative AI model with rule-based post-processing. The server, for example, applies jurisdiction-specific thresholds and formulae to adjust certain payment items computed by the generative model. The server uses configuration files that specify tax brackets and fee tables and applies these rules as deterministic corrections on top of the generative output. This hybrid processing yields higher accuracy than either purely generative or purely rule-based systems, because the generative AI model provides context-sensitive itemization while the rules enforce strict numerical consistency.

The system can be further varied in that the terminal type, communication protocol, database technology, and specific neural-network architecture can differ without departing from the scope of the invention. The terminal may be a dedicated kiosk, a wearable device, or an in-vehicle device, as long as the terminal can send succession-related information and render display data. The server may use different programming languages and frameworks, such as a different web framework or a different database system, provided that the server still implements modules corresponding to input analysis, prompt sentence generation, generative-model interaction, payment plan computation, storage, display data generation, and transaction processing. The generative AI model may be a different large language model architecture, a mixture-of-experts model, or a fine-tuned domain model, as long as the server controls the model through prompt sentences and obtains machine-readable payment plan information.

By integrating these elements, the server improves computer technology itself. The specific use of natural language processing to convert unstructured succession-related information into structured internal data, the deterministic construction of constrained prompt sentences, the normalization of generative model outputs into structured payment plans, and the direct coupling to transaction processing are technical features that enhance the operation of the server as an information processing device. The system achieves technical effects including increased processing speed, reduced user error, improved data consistency, and reduced computational and communication overhead compared with conventional systems that do not employ such integrated processing.

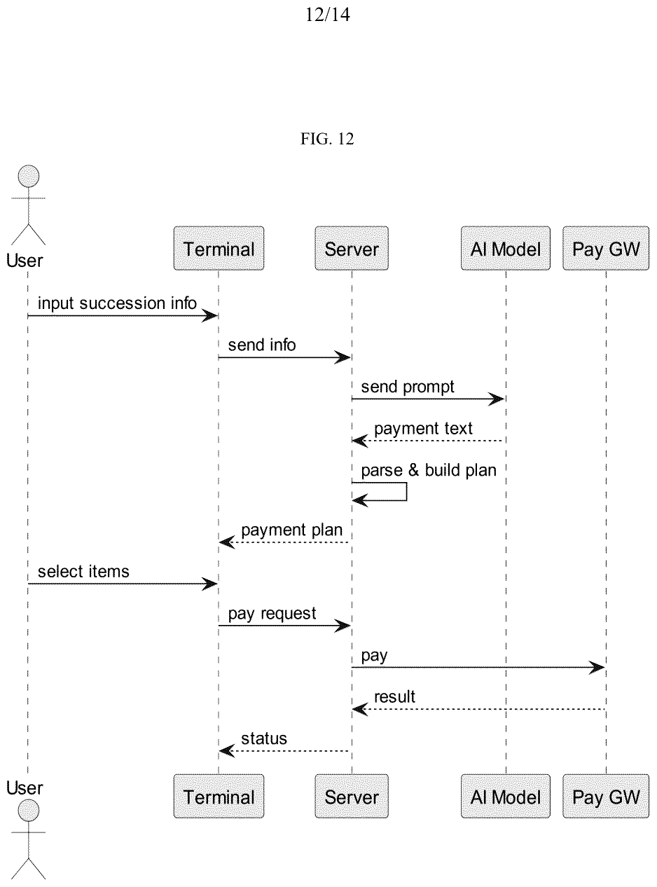

The following describes the processing flow using FIG. 12.

### Step 1:

User operates the terminal to input succession-related information.

User enters natural language text such as a description of assets and relationships (for example, “I want to handle the inheritance procedure for my father's estate. There is one house worth about 30 million yen and deposits of 5 million yen. The heirs are me and my younger sister.”), and user inputs or selects structured values such as estimated amounts and number of heirs. The input of this step is raw user-entered text and selected values on the terminal screen. The output of this step is a local data structure on the terminal, containing both the raw text and the structured fields, ready to be transmitted to the server.

### Step 2:

Terminal converts the user input into a structured request and transmits it to the server.

Terminal serializes the local data structure into a standardized representation, for example a key-value map containing fields for description, asset values, and number of heirs. Terminal performs basic validation such as checking that numeric fields contain only digits and that required text fields are not empty. The input of this step is the internal representation of the user's entries. The terminal applies data formatting and validation operations to transform the internal representation into a structured request message and outputs a network request that is sent to the server over a communication network.

### Step 3:

Server receives the structured request and stores the raw succession-related information.

Server accepts the incoming request via a communication interface, decodes the message, and extracts individual fields such as the natural language description, asset indicators, and counts of successors. The input of this step is the structured request message from the terminal. The server performs parsing, assigns a unique identifier, and writes the extracted fields into persistent storage associated with that identifier. The output of this step is a stored record that serves as the source data for subsequent analysis.

### Step 4:

Server analyzes the succession-related information using a natural language processing component.

Server passes the natural language description to a natural language processing module that performs tokenization, part-of-speech tagging, and named-entity recognition. The input of this step is the raw text field stored in the record. The server applies algorithms that segment the text into tokens, classify each token, and detect entities such as monetary amounts, asset types, and kinship relations. The server then converts the detected entities and attributes into structured internal data, such as feature vectors and entity lists. The output of this step is a structured internal representation of the user's textual description aligned with numeric and categorical fields.

### Step 5:

Server constructs a prompt sentence for a generative ai model based on the structured internal data.

Server combines the structured internal data with predefined instruction templates to generate a prompt sentence. The input of this step is the structured internal representation (for example, estate value, number of heirs, relationship to the deceased) and a prompt template. The server performs string concatenation and template filling; it inserts the specific values into fixed textual slots to form a coherent instruction. For example, the server outputs a prompt sentence such as: “You are an assistant that calculates all payments required for inheritance procedures. Using the following input, list each required payment item and its estimated amount, and provide a short explanation for each item. Input: I want to handle the inheritance procedure for my father's estate. There is one house worth about 30 million yen and deposits of 5 million yen. The heirs are me and my younger sister.” The output of this step is a finalized prompt sentence ready to be transmitted to the generative AI model.

### Step 6:

Server transmits the prompt sentence and configuration parameters to the generative AI model and receives a generated response.

Server sends a request containing the prompt sentence and model parameters such as maximum response length and sampling temperature to a remote or local generative AI model via a model access interface. The input of this step is the prompt sentence and configuration values. The generative AI model processes the prompt using its neural network architecture and returns generated text that describes payment items and amounts. The server receives this generated text as a model response. The output of this step is raw model output text containing a candidate payment plan, typically formatted according to the constraints specified in the prompt sentence.

### Step 7:

Server parses the model response and computes a structured payment plan.

Server feeds the raw model output text into a parsing routine that interprets the identified payment items and amounts. The input of this step is the generated text returned by the generative AI model. The server applies pattern-matching rules or deterministic parsing functions to detect item names, numeric amounts, and explanatory phrases. The server converts textual amounts to numeric values by removing non-numeric characters and performing unit normalization. The server then aggregates these values to compute a total payment amount by summing individual item amounts. The output of this step is a structured payment plan data set comprising an array or list of payment items, each with an associated name, amount, and description, along with a computed total amount.

### Step 8:

Server normalizes and stores the payment plan information in association with identification information.

Server maps the structured payment plan into a database schema that associates each payment item and total amount with the underlying succession case identifier and user identifier. The input of this step is the structured payment plan data set and the identifiers created in earlier steps. The server executes database operations to insert or update records in tables or collections representing succession cases, payment items, and plan metadata. The output of this step is a durable, normalized representation of the payment plan stored within a storage device, ensuring consistency and retrievability for subsequent use.

### Step 9:

Server generates display data from the structured payment plan for presentation on the terminal.

Server constructs display-oriented data that includes formatted text labels, currency-formatted numbers, and layout hints such as ordering and grouping of payment items. The input of this step is the normalized payment plan data stored in the database. The server applies formatting operations, for example adding thousands separators to numeric values, appending currency labels, and marking status fields as “unpaid” or “pending.” The server packages these elements into a display data structure designed to be easily rendered by the terminal. The output of this step is display data that encapsulates the payment plan in a form suitable for user presentation.

### Step 10:

Terminal receives the display data and renders the payment plan for the user.

Terminal accepts the display data sent by the server, decodes it, and updates the user interface components to show itemized payment information and totals. The input of this step is the display data structure delivered via the communication network. The terminal performs layout operations, such as populating list components, setting text labels, and applying visual styling. The output of this step is a rendered screen on the terminal display containing the structured payment plan, enabling the user to understand the required payments.

### Step 11:

User reviews the displayed payment plan and selects payment items to be executed.

User examines the presented list of payment items and uses interactive elements on the terminal, such as check boxes or buttons, to select one or more items to pay. The input of this step is the visualized payment plan and the user's intentions. Through interactions, the user indicates selected items and confirms the desire to proceed with payment. The output of this step is a set of selections captured by the terminal as a local selection data structure indicating which items and amounts are to be submitted for payment.

### Step 12:

Terminal creates a payment request based on the user's selections and sends it to the server.

Terminal gathers the selected payment items, associated amounts, and any payment method information (for example, a tokenized payment method identifier) from its local state. The input of this step is the selection data structure produced in the previous step. The terminal performs data aggregation to compute the sum of selected item amounts and combines this total with identifiers and payment method parameters into a payment request message. The terminal then transmits this message to the server using a secure communication protocol. The output of this step is a payment request received by the server, containing itemized details and a total to be charged.

### Step 13:

Server executes payment processing by communicating with a transaction processing apparatus.

Server takes the payment request as input and verifies that the selected items correspond to those stored in the normalized payment plan for the relevant user and succession case. The input of this step is the payment request message from the terminal and the stored payment plan data. The server performs verification and then generates an electronic payment instruction, including the total amount, currency, and payment method identifier. The server transmits this instruction to a transaction processing apparatus via the financial transaction interface and receives a payment result, such as success or failure status and transaction identifiers. The output of this step is a confirmed payment result associated with the respective payment items in the server's database.

### Step 14:

Server updates the stored payment plan information based on the payment result and generates updated display data.

Server uses the payment result as input to adjust the status fields of the corresponding payment items in the stored data. The input of this step is the payment result and the previously stored payment plan records. The server performs update operations to mark items as “paid” and to store transaction identifiers and timestamps. The server then constructs new display data reflecting the updated status of each item and, if necessary, recalculates remaining unpaid totals. The output of this step is updated display data that accurately represents the post-payment state of the payment plan.

### Step 15:

Terminal presents the payment completion status to the user.

Terminal receives the updated display data from the server and uses it to refresh the visual representation of the payment plan. The input of this step is the updated display data that includes new status indicators and any confirmation messages. The terminal performs UI updates, such as replacing “Pay” buttons with “Paid” labels and showing a confirmation message that indicates successful completion of specific payments or the entire plan. The output of this step is a display on the terminal that informs the user that the selected payments have been executed, completing the processing flow for those payment items.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional inheritance management systems and end-of-life support tools for online accounts are largely static and rule-based. Such systems typically present fixed electronic forms and simple checklists, and rely on manual reading of guidelines and manual execution of procedures by users. As a result, these systems suffer from several technical problems when implemented on general-purpose computers and communication networks. First, a processor of such a system is required to perform repeated input/output operations and branching processes for each individual service and procedure, which leads to an increase in processing complexity, memory usage, and network traffic when handling diverse and frequently changing procedures of multiple external services. Second, known systems do not automatically transform unstructured inheritance-related descriptions from users into structured machine-executable workflows; instead, the system simply stores or displays natural language text, forcing a human operator to perform mapping and orchestration. This results in inefficient utilization of processing resources, duplication of data processing, and an increased number of communication round trips between client terminals and external services.

Furthermore, with respect to social network type information providing services, conventional approaches require the user or an operator to manually search for accounts of a deceased person, interpret platform-specific instructions, and then manually submit deletion requests or death notifications. This manual process causes inconsistent use of external communication interfaces, increases the number of erroneous or incomplete requests, and leads to a fragmented state of progress information stored in the system. The processor is unable to automatically correlate account discovery, procedure selection, and execution states across multiple external services, which complicates error handling and recovery, and degrades the reliability and responsiveness of the system as perceived at the terminal.

Additionally, existing systems do not effectively exploit generative AI models as part of the core control flow of the processor. In conventional designs, generative AI outputs, if used at all, are treated as passive textual hints and are not integrated into the internal task representation or scheduling logic. Consequently, the system cannot consistently classify AI-generated procedural guidance into executable tasks, cannot selectively offload suitable steps to automated external interface calls, and cannot unify progress and notification management across automated and manual steps. This results in suboptimal allocation of computational and network resources, redundant state transitions, and increased latency when responding to user actions at the terminal. Therefore, there is a need for an improved computer-implemented system and processing method in which a processor cooperates with a storage device, a communication interface, and a generative AI model to (i) transform heterogeneous inheritance-related inputs and AI-generated text into structured procedure information, (ii) classify and orchestrate these procedures into automated and manual tasks, (iii) automatically drive external information processing services via communication interfaces, and (iv) maintain unified progress and notification states. By doing so, the system can reduce computational overhead, streamline external service interactions, and enhance the efficiency and reliability of inheritance-related and social network account end-of-life processing.

The specific processing by the specific processing unit 290 of the data processing device 12 in Example 2 is realized by the following means.

The present invention provides a server comprising a processor, a storage device, and a communication interface, the processor being configured to receive inheritance-related information including information of a transferor and information of a transferee from a terminal and to analyze the received inheritance-related information by using a natural language processing technique; to generate and input a prompt sentence to a generative AI model on the basis of an analysis result and the inheritance-related information, and to obtain, from the generative AI model, natural language text including contents of required inheritance-related procedures and documents; to acquire, on the basis of the inheritance-related information, identification information related to the transferor that is stored in the storage device, and, by using the identification information, to specify, via a communication interface of an external information processing service, a plurality of user account candidates related to the transferor; to present the plurality of user account candidates to the terminal, and, on the basis of a selection result of user accounts received from the terminal and processing contents designated for each of the user accounts, to automatically transmit, via the communication interface of the external information processing service, a deletion request or a death notification request for the user accounts; to input, to the generative AI model, a prompt sentence from a user and context information including information of the specified user accounts, and to obtain, from the generative AI model, an explanatory text of procedures corresponding to the prompt sentence and procedure information indicating processing steps for the user accounts; to analyze the obtained procedure information to classify processing into processing executable automatically and processing requiring manual execution by the user, to automatically execute the processing executable automatically via the communication interface of the external information processing service, and to visualize and present, to the terminal, the processing requiring manual execution by the user; and to record, in the storage device, progress states and completion states of respective processing on the basis of processing result information acquired from the external information processing service, and to transmit, to the terminal, notification information indicating the progress states and the completion states. This enables the server to internally convert unstructured inheritance-related input and generative AI output into structured, executable workflows, to reduce redundant user interactions and external communication calls, to orchestrate automated and manual tasks across multiple external services in a unified manner, and thereby to improve the overall efficiency, scalability, and reliability of computer-based inheritance management and social network account end-of-life processing.

The term “system” refers to a combination of at least one server, at least one terminal, a communication network, and associated hardware and software components that cooperate to perform inheritance-related processing and social network account end-of-life support.

The term “server” refers to an information processing apparatus including at least one processor, at least one storage device, and at least one communication interface, and configured to execute the main control logic of the invention.

The term “processor” refers to a hardware computation unit, such as a central processing unit or a programmable logic device, configured to execute instructions that realize the functions described in the claims.

The term “storage device” refers to a non-transitory computer-readable medium, such as a semiconductor memory, a magnetic storage device, or an optical storage device, configured to store programs, configuration data, inheritance-related information, account information, workflow information, and logs.

The term “communication interface” refers to a hardware and software communication component, such as a network interface controller, a communication port, or a communication module, configured to transmit and receive data over a communication network using predetermined communication protocols.

The term “terminal” refers to a user-operated information processing apparatus, such as a personal computer, a smartphone, or a tablet device, configured to exchange data with the server and to present information to a user.

The term “user” refers to a human operator who uses the terminal to provide input to the system and to receive output from the system, and includes a transferor, a transferee, an heir, an administrator, or a representative.

The term “transferor” refers to a person whose property or rights are subject to inheritance or succession processing, and includes a deceased person or a person preparing for end-of-life procedures.

The term “transferee” refers to a person who has a right or obligation to receive property or rights from the transferor through inheritance or succession.

The term “inheritance-related information” refers to information related to inheritance or succession, including at least one of personal identification information, contact information, relationship information, property information, and procedural preference information regarding a transferor and a transferee.

The term “identification information” refers to information that can be used to uniquely or nearly uniquely associate data with a person, such as a name, an address, a contact detail, an identifier, or a combination of such elements.

The term “external information processing service” refers to a remotely provided information processing function accessible via a communication network, including at least online platforms, web services, and account management services operated by third parties.

The term “social network type information providing service” refers to an online platform that provides user accounts and enables users to post, share, or exchange information with other users through a network.

The term “user account” refers to an identifier and associated data managed by an external information processing service or a social network type information providing service, and representing a logical entity through which a user accesses the service.

The term “user account candidate” refers to a user account that is potentially associated with a particular transferor and is identified by the system through matching of identification information.

The term “inheritance-related procedure” refers to a sequence of operations required to legally or administratively process succession of property or rights of a transferor to a transferee.

The term “task information” refers to structured data representing a unit of work within an electronic workflow, including information such as a task type, a related account, a status, and a deadline.

The term “electronic workflow” refers to a sequence of tasks represented in a machine-readable format and managed by the server for execution, scheduling, and tracking in relation to inheritance-related procedures.

The term “natural language processing technique” refers to a computational method for analyzing and processing text written in a natural human language to extract structures, meanings, or entities.

The term “generative AI model” refers to a machine learning model, such as a large language model, configured to generate natural language text or structured output in response to an input prompt.

The term “prompt sentence” refers to an input text provided to the generative AI model, describing a request, a question, or a context for which the generative AI model generates a response.

The term “natural language text” refers to text composed in a human language, such as sentences or paragraphs, that can be read and understood by a human user.

The term “explanatory text” refers to natural language text generated or provided by the system, which describes procedures, steps, or instructions related to inheritance or account processing.

The term “procedure information” refers to structured data that represents one or more processing steps, their order, and their relationships, derived from an analysis of explanatory text or other sources.

The term “processing executable automatically” refers to a processing step that can be carried out by the server, without requiring direct manual input at the time of execution, by using communication interfaces and stored data.

The term “processing requiring manual execution” refers to a processing step that necessitates direct human action, such as preparing documents, performing authentication, or manually operating an external service interface.

The term “deletion request” refers to an electronic request message transmitted to an external information processing service, instructing the service to delete or deactivate a user account or associated data.

The term “death notification request” refers to an electronic message transmitted to an external information processing service, informing the service that the user account holder is deceased and requesting that the account be processed according to a death-related policy.

The term “context information” refers to additional data transmitted together with a prompt sentence to the generative AI model, including at least current case information, user account information, and system state information.

The term “progress state” refers to information indicating a current stage or intermediate status of a particular processing task or workflow.

The term “completion state” refers to information indicating that a particular processing task or workflow has finished, including whether the processing has succeeded, failed, or requires further action.

The term “notification information” refers to data that is generated by the server and transmitted to the terminal to inform a user of a progress state, a completion state, a reminder, or other status related to processing.

The term “reminder notification” refers to notification information that indicates a pending or overdue manual processing task, and prompts the user to perform an associated action.

In one embodiment, a server implements the claimed system by executing computer programs on hardware including at least one multi-core central processing unit, a main memory, a non-transitory storage device, and a network interface card connected to a communication network. The server runs an operating system such as a general-purpose server operating system and application software including a web server, an application framework, a database management system such as a relational database engine, and a generative AI model serving framework. The server stores executable instructions and data structures in a storage device such as a solid-state drive, and loads program modules into main memory for execution by the processor.

In this embodiment, the server cooperates with one or more terminals. The terminal includes, for example, a smartphone, a tablet, or a personal computer equipped with a display, an input device, a central processing unit, a memory, and a communication interface. The terminal runs client software such as a web browser or a dedicated application that communicates with the server over a secure communication protocol using the communication interface. The terminal presents user interfaces for inheritance-related processing and displays results received from the server.

The server stores inheritance-related information in structured data records in the relational database. The server defines tables such as a case table, a person table, a contact table, an account table, a task table, and an interaction table. The case table stores case identifiers, transferor identifiers, transferee identifiers, and status fields. The person table stores normalized identifiers, names, dates of birth, and other attributes. The contact table stores email addresses, telephone numbers, and addresses linked to persons. The account table stores information of user accounts on external information processing services, including platform type, external account identifier, matching score, and status. The task table stores task type, associated case, target account, schedule, and progress information. These data structures allow the server to efficiently index and retrieve inheritance-related information using indexed queries, thereby improving retrieval performance and reducing processing time compared to unstructured storage.

The server receives inheritance-related information including information of a transferor and information of a transferee from a terminal. The terminal formats the inheritance-related information into form fields such as transferor name, multiple email addresses, telephone numbers, country, and a list of potential external services. The terminal transmits the inheritance-related information to the server over a secure communication channel. The server validates the received fields according to predetermined schemas and stores the validated information into the corresponding database tables. Because the server normalizes repeated data into related tables, the server reduces redundancy and improves consistency of stored data.

The server applies a natural language processing technique to free-form descriptions provided by the user, such as additional comments or instructions. The server uses a natural language processing library to perform tokenization, part-of-speech tagging, named-entity recognition, and dependency parsing on the text. The server identifies entities such as personal names, locations, service names, and document types from the text and maps them to standardized codes stored in a configuration table. For example, if the user enters the phrase “my father's social media accounts and email accounts,” the server extracts “social media accounts” and “email accounts” as category entities and associates them with predefined platform groups. This structured extraction allows the server to derive machine-readable parameters from unstructured language, which improves automation and reduces the need for manual configuration.

The server generates and inputs a prompt sentence to a generative AI model. In this embodiment, the generative AI model is implemented as a transformer-based neural network with multiple attention layers, feed-forward layers, and positional encodings. The model is pre-trained on large corpora of text and fine-tuned on a dataset of procedural descriptions related to account management, inheritance law explanations, and step-by-step workflows. The server constructs an input prompt sentence by combining the analysis result of the inheritance-related information and context data from the database. For example, the server generates a prompt sentence such as: “Generate a step-by-step list of required procedures and documents to handle inheritance of online accounts for a deceased person with Facebook and Twitter accounts, based on the following profile: name: [NAME], country: [COUNTRY], relationship: child.”

The server transmits the prompt sentence to the generative AI model using an application programming interface. The generative AI model outputs a sequence of tokens that the server decodes into natural language text. The generated text includes contents of required inheritance-related procedures and documents. The server parses the generated text by using a rule-based template extractor, converting sections and enumerated lists into internal procedure information structures stored in the task table.

The server also accepts prompt sentences directly from the user via the terminal. The user can enter, for example, a prompt sentence such as:
“Explain the exact procedure to request deletion of my deceased father's Facebook and Twitter accounts using this system.”

The terminal transmits the prompt sentence to the server, and the server includes current case context information such as existing accounts and tasks. The server forms a combined input that includes the user's prompt sentence and context information and sends it to the generative AI model. The generative AI model returns explanatory text and implicit step structures. The server converts these structures into explicit procedure information entries, each entry specifying a step description, an operation type, a target account, and an execution mode (automatic or manual). In this embodiment, the generative AI model is implemented on a separate model serving node equipped with one or more graphics processing units. The server communicates with the model serving node through a network interface by sending encoded token sequences and receiving results. The model serving node uses a transformer architecture with self-attention mechanisms to compute probability distributions over output tokens. The node uses a cross-entropy loss function during training and applies backpropagation to update model weights through an optimizer such as Adam. The training dataset is augmented by paraphrasing, template variations, and synthetic combinations of account management scenarios, which improves robustness and generalization. Because the model learns to generate structured, predictable procedure descriptions, the server can reliably parse the output into internal procedural representations, which is technically advantageous over generic text generation.

The server acquires identification information related to the transferor from the storage device and uses this identification information to specify a plurality of user account candidates. The server executes parameterized queries to the person table and contact table using indexed columns such as email and telephone. The server obtains identifiers and associated attributes and uses them as features to build search queries to external information processing services. The server constructs requests for each external service's application programming interface, including parameters such as name, email, and telephone number. The server transmits the requests through the communication interface and receives responses containing user account candidate data. The server computes a similarity score for each candidate by applying a matching algorithm that combines string similarity for names, exact matching for email addresses, and weighted matching for country and other attributes. The server stores candidate accounts with scores above a threshold in the account table with a status field indicating that the account is a candidate.

The terminal presents the plurality of user account candidates and allows the user to confirm or reject them. The terminal receives the candidate accounts as structured data and renders a list with names, profile images, and platform types. The user selects the accounts that belong to the transferor and specifies desired processing contents for each account, such as deletion request or death notification. The terminal transmits the selection and processing contents to the server. The server updates the account table entries to indicate confirmed accounts and associates each account with a requested operation stored in the task table.

The server uses the procedure information generated from the generative AI model and the confirmed account information to classify processing into automatic steps and manual steps. The server applies rules stored in a capability table that indicates, for each external service and each operation type, whether an application programming interface is available and whether server-side execution is possible. The server flags steps with available automatic execution paths as automatic and others as manual. The server then configures automatic steps as tasks with specific endpoints and payloads for the external service application programming interfaces. For manual steps, the server generates instructions and displays them on the terminal.

The server automatically executes automatic steps by transmitting deletion requests or death notification requests to external information processing services. The server constructs hypertext transfer protocol requests with appropriate authentication tokens and payloads. When an external service requires document uploads, the server retrieves document files from the storage device, such as scanned death certificates stored in object storage, and attaches the files to the requests in a supported format. By automating the aggregation of identity data, document retrieval, and protocol-level request construction, the server reduces the number of manual operations required by human operators and ensures that requests conform to platform-specific technical requirements.

The server records progress states and completion states of each processing task. The server writes rows into a log table for each attempt, including timestamps, request identifiers, response codes, and parsed result statuses. The server updates the task table with updated progress and completion states. The server generates notification information summarizing changes and transmits these notifications to the terminal. The terminal displays status indicators, such as “in progress,” “completed,” or “requires additional documents,” allowing the user to monitor system actions without manually tracking details. This unified state management reduces the need for repetitive polling and re-entry of information, thereby reducing communication load and processing overhead.

The server converts inheritance-related procedures and tasks concerning property succession into structured task information. The server represents each task as a record containing fields such as task type, precedence constraints, estimated execution duration, and required data. The server associates these tasks with procedure information obtained from the generative AI model. The server uses a scheduling algorithm to assign execution times and priorities to automatic tasks, taking into account external service rate limits and network load. The server also calculates deadlines for manual tasks and generates reminder notifications when deadlines approach or are exceeded. By integrating AI-derived procedures into a formal task graph and scheduling algorithm, the server achieves technical improvements in orchestrating asynchronous operations across distributed services.

From a technical perspective, this embodiment improves computer technology in multiple ways. First, the server's transformation of unstructured inheritance-related text and generative AI model output into normalized procedure information and task data structures reduces complexity of later processing and improves execution efficiency, because subsequent modules operate on fixed-length, indexed fields rather than parsing text repeatedly. Second, the integration of the generative AI model into the core control flow enables dynamic generation of procedure templates that adapt to different external service configurations and jurisdictions without requiring static rule updates, reducing maintenance overhead and memory footprint for hardcoded rules. Third, the account candidate matching algorithm and task scheduling based on explicit data structures reduce redundant communication calls by consolidating similar operations and batching requests to external services.

The generative AI model in this embodiment is not used merely to mimic human reasoning but to generate machine-consumable structures. The server defines a constrained prompting format that instructs the model to output numbered steps and labeled sections. The server then parses these outputs using a deterministic parser that recognizes labels and step markers. For example, the server expects output in the form:
“Step 1: Collect documents . . .
Step 2: Submit online form . . .
Platform A specific note: . . .
Platform B specific note: . . . ”

The server uses pattern matching to extract “Step 1,” “Step 2,” and platform-specific notes and then maps these to internal task types with platform identifiers. This non-conventional combination of generative text modeling with deterministic structural parsing yields an effective procedure extraction pipeline that is more flexible than fixed templates yet more structured than free-form text, leading to improved accuracy and fewer parsing failures.

The generative AI model itself can be trained using supervised fine-tuning on a dataset containing pairs of input prompts and desired structured procedure descriptions. The server or an offline training system uses a sequence-to-sequence training objective where the loss function is calculated as a token-wise cross-entropy between predicted tokens and reference tokens. Training uses a mini-batch gradient descent algorithm with weight updates computed using backpropagation. Data augmentation techniques include generating paraphrases of prompts and slightly modifying procedural steps while preserving logical structure, thereby improving the model's robustness to variations in user language. Because the model learns to output stable procedural patterns even for varied input prompts, the server can rely on consistent structural features for downstream processing, which is a technical advantage compared to conventional natural language tools.

The server utilizes a workflow module that maintains a directed acyclic graph of tasks for each case. The workflow module enforces dependencies, so that certain automatic calls to external services do not occur before required identification or documentation tasks are completed. The workflow module also manages concurrency to ensure that the server does not exceed rate limits of external services. For example, the workflow module can limit the number of concurrent deletion requests to a particular external service. By structuring tasks in this way, the server prevents inefficient retry storms and reduces the likelihood of throttling or failures, which improves overall system reliability and throughput.

In another embodiment, the server deploys multiple generative AI models, each fine-tuned for specific domains such as social network accounts or financial accounts. The server selects an appropriate model based on the content of the inheritance-related information or the external service type. This modular use of different models allows the server to optimize model size and inference latency. Smaller domain-specific models can respond faster and consume less computational resources, enabling the server to provide timely guidance even under high load. This results in improved response time for users and more efficient utilization of server hardware.

The terminal cooperates with the server to reduce user input repetition and communication overhead. The terminal caches certain static data such as lists of external services and explanation texts. When the server transmits updates only for dynamic data such as task statuses, the terminal can render updated views without re-requesting static texts. This reduces bandwidth consumption and processing time on both the server and terminal sides.

The user interacts with the system by submitting prompt sentences and providing confirmations. The user can refine procedures suggested by the generative AI model by accepting, rejecting, or modifying specific tasks in the interface provided by the terminal. When the user adjusts tasks, the terminal transmits only the changed fields to the server, and the server updates the workflow graph accordingly. This incremental update mechanism avoids full recomputation of the workflow and reduces the computational burden on the server.

Because the server leverages generative AI models, structured task representations, optimized database data structures, and coordinated communication with external information processing services, the overall system achieves technical effects including reduced processing time, minimized redundant network traffic, improved accuracy in account matching and task extraction, and consistent progress tracking. These improvements arise from specific data structures, algorithms, and control flows described above, rather than from mere automation of a human administrative process.

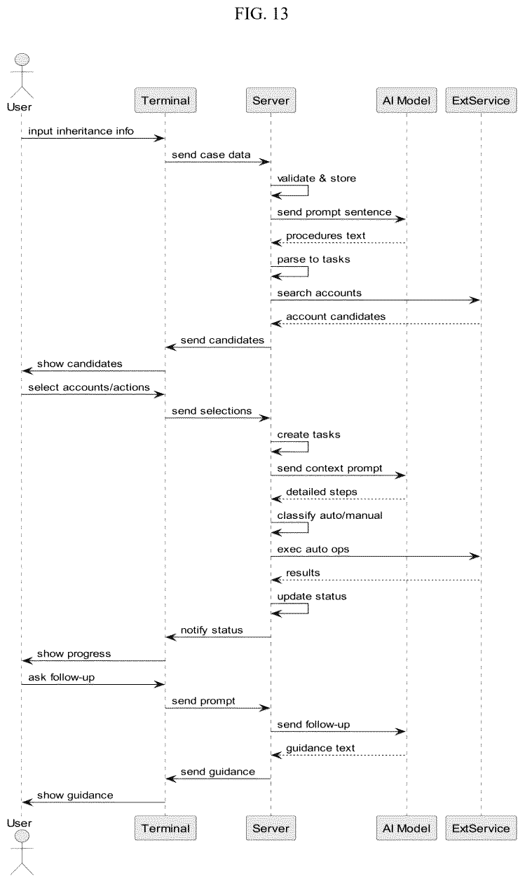

The following describes the processing flow using FIG. 13.

### Step 1:

Server initializes core modules and data structures.

Server loads configuration parameters from a storage device, including database connection settings, external service endpoint URLs, authentication credentials, and model endpoint addresses. As input, server reads configuration files and environment variables; as output, server produces in-memory configuration objects used by subsequent modules. Server establishes connections to a relational database, initializes a workflow manager, and prepares an HTTP client for communication with external information processing services and with a generative AI model.

### Step 2:

Terminal presents an inheritance information input screen to the user.

Terminal uses stored user interface templates and configuration data as input and renders form fields for transferor information, transferee information, and suspected external services. As output, terminal displays input controls for name, email addresses, phone numbers, country, relationship, and a list of social network type information providing services. Terminal waits for user input events on these controls.

### Step 3:

User enters inheritance-related information and submits it to the server.

User types textual data such as the transferor's name, contact details, and free-form comments, and selects checkboxes for external services that may hold user accounts. The input is the user's keystrokes and selections; the output is a structured payload in the terminal's memory. Terminal validates basic formats, then sends a request containing this payload to the server over a secure communication channel.

### Step 4:

Server receives and validates inheritance-related information.

Server takes the structured payload from the terminal as input and checks required fields, data types, and constraints. Server performs data processing such as trimming strings, normalizing phone numbers, and checking for invalid characters. As output, server generates validated and normalized records for a case entity, a transferor entity, and a transferee entity, and stores them in corresponding database tables.

### Step 5:

Server performs initial natural language processing on free-form text.

Server receives free-form description fields from the inheritance-related information as input and applies natural language processing operations such as tokenization, part-of-speech tagging, and named entity recognition. Server extracts entities like service names, document types, and relationship terms. As output, server produces an entity list and mapped codes, which are stored in an internal structure linked to the case. Server uses this processed data to enrich subsequent prompts and search criteria.

### Step 6:

Server constructs and sends a first prompt sentence to the generative AI model.

Server takes as input the normalized inheritance-related information, the extracted entities, and configuration data defining a template for prompts. Server concatenates these elements into a prompt sentence that requests a list of required procedures and documents. Server, for example, generates a prompt sentence such as: “Generate a step-by-step list of required procedures and documents to handle inheritance of online accounts for a deceased person with social network accounts, based on the following profile: [profile data].” As output, server creates a formatted text string and sends it via an HTTP client to the generative AI model endpoint.

### Step 7:

Server receives and parses generative AI model output.

Server obtains natural language text generated by the generative AI model as input. Server processes this text by splitting it into lines, detecting labels like “Step 1” or bullet markers, and mapping each segment into a structured procedure item. Server performs data processing operations that convert unstructured text into a list of step objects, each with a description and a step index. As output, server stores these procedure items as records in a task-related table associated with the case.

### Step 8:

Server retrieves identification information and searches for external user account candidates.

Server takes as input the transferor's identifiers from the person and contact tables, including name, email addresses, and phone numbers. Server uses this data to build search queries for external information processing services. Server sends these queries via the communication interface to external service application programming interfaces. Server receives responses as structured data, then calculates similarity scores by comparing fields such as names and emails. As output, server generates a list of user account candidates with associated scores and persists them in the account table with a candidate status.

### Step 9:

Terminal presents user account candidates to the user.

Terminal receives the list of user account candidates and associated metadata from the server as input. Terminal processes this data by mapping platform types to icons, converting status codes to label strings, and formatting names and profile details for display. As output, terminal renders a selection interface where each candidate account is listed with identifying information and selectable controls, enabling the user to confirm or reject each candidate.

### Step 10:

User selects valid accounts and desired operations.

User reviews the displayed account candidates on the terminal. The input is the visible list of candidates; the output is user interaction events such as taps or clicks on selection controls and operation type options like deletion or death notification. Terminal aggregates these selection states and operation types into a structured payload and sends it to the server.

### Step 11:

Server assigns selected accounts and operations to internal tasks.

Server receives the confirmed account identifiers and selected operations as input. Server performs data processing by updating account records to mark them as confirmed and associating each account with an operation code. Server creates new task records that reference the case, the account, and the operation type. As output, server stores these task records in the task table and sets an initial status for each task.

### Step 12:

Server refines procedure information with a context-aware prompt sentence.

Server takes as input the existing procedure items, confirmed accounts, and user role information. Server constructs a new prompt sentence directed to the generative AI model, including context information such as platform types and jurisdiction. For example, server may create a prompt sentence: “Explain the exact procedure to request deletion of the following social network accounts for a deceased person using this system: [account list].” Server sends this prompt sentence and context to the generative AI model. As output, server receives an explanatory text and implicit structure that will inform further task classification.

### Step 13:

Server classifies tasks into automatic and manual categories.

Server uses as input the refined procedure information and rules stored in a capability table indicating which operations are executable via application programming interfaces. Server performs data processing by matching each procedure item and task against the capability rules. Server labels tasks with a mode field indicating automatic or manual. As output, server updates the task records with execution mode flags and, for automatic tasks, attaches required endpoint and payload templates.

### Step 14:

Server prepares and executes automatic external service operations.

Server takes automatic tasks and associated account data as input. Server composes payloads for external service application programming interfaces, including account identifiers, request types, and, when required, document references. Server retrieves document files from storage, encodes them according to protocol specifications, and sends requests via the communication interface. As output, server receives response codes and bodies from external services and logs them in an action log table.

### Step 15:

Server updates task progress and completion states.

Server uses the external service responses as input. Server performs data processing by interpreting response codes, mapping them to standardized internal statuses such as “in progress,” “completed,” or “requires additional information.” Server updates corresponding task records with new progress and completion states and writes detailed log entries including timestamps and error messages when applicable. As output, the database reflects the current state of each automated operation.

### Step 16:

Server generates notification information for the terminal.

Server takes as input the updated task states and logs. Server summarizes status changes into concise notification objects that include the case identifier, affected account, operation type, and new status. Server stores these notifications in a notification table and transmits selected notifications to the terminal over the communication interface. As output, notification messages are delivered and ready for display.

### Step 17:

Terminal displays progress and manual instructions to the user.

Terminal receives notification information and procedure explanations from the server as input. Terminal performs data processing by grouping notifications by case and account, and by extracting manual steps from procedure information associated with manual tasks. As output, terminal presents an updated view with progress indicators, completion marks, and human-readable instructions for manual actions that the user needs to perform outside automatic channels.

### Step 18:

User interacts with the generative AI model through additional prompt sentences.

User, viewing the current state and instructions, enters follow-up questions to seek clarification. For example, user may input a prompt sentence such as: “Generate a sample email that I can send to a support team if an automatic deletion request is rejected.” The input is the user's textual question; the output is a formatted prompt sentence in the terminal's memory. Terminal sends the prompt sentence and current context to the server.

### Step 19:

Server processes follow-up AI assistance and integrates results.

Server takes the follow-up prompt sentence and updated case context as input. Server constructs a combined input for the generative AI model, sends it, and receives generated text such as a sample email or detailed explanation. Server parses and, when appropriate, stores this text in an interaction table linked to the case. As output, server provides the refined explanation or template back to the terminal for display, allowing the user to apply the guidance without additional manual research.

### Step 20:

Server maintains and optimizes the workflow over time.

Server periodically uses task states, log statistics, and interaction records as input to optimize scheduling and resource allocation. Server adjusts parameters such as concurrency limits and retry intervals based on historical success rates and response times. As output, server updates configuration data used by the workflow manager, thereby improving processing efficiency, reducing communication load to external services, and maintaining a coherent and up-to-date workflow for each inheritance-related case.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented systems for handling inheritance procedures and digital account end-of-life operations are typically designed as static workflow engines or simple form-based applications. These conventional systems suffer from several technical limitations.

First, conventional systems usually treat user input as rigidly structured data and are not capable of robustly processing unstructured natural language input that mixes legal facts, personal circumstances, and emotional expressions. As a result, such systems require extensive manual preprocessing and configuration by operators, which increases processing latency, raises error rates in data extraction, and reduces the scalability of the system when deployed on general-purpose computing platforms.

Second, conventional systems do not dynamically adapt their computational behavior based on a user's emotional state. User interfaces and backend responses are typically fixed or rule-based and do not use emotion analysis to control how explanations, prompts, and workflow steps are generated and presented. This leads to a mismatch between the system's interaction pattern and the user's cognitive load, which in turn increases abandonment rates, causes redundant client-server interactions, and results in inefficient use of computing and network resources.

Third, existing platforms that manage social or information-exchange accounts at the end of a user's life commonly rely on manual, service-specific steps and do not provide a unified, machine-executable abstraction for account operations across heterogeneous network services. These systems generally do not model, in a machine-readable way, the relationships among: (i) stored account identifiers and credentials, (ii) platform-specific communication rules, (iii) verified death status, and (iv) emotional context and preferences. Consequently, they require human operators to interpret terms of service, draft messages, and issue API calls on a per-platform basis, which leads to inconsistent behavior, high risk of errors, and poor fault-tolerance.

Fourth, many systems that incorporate generative AI models do so in a loosely coupled manner, where the generative model is called in an ad hoc fashion without a structured prompt-generation layer that takes into account both normalized legal data and emotion-derived context. Without such a layer, the system cannot reliably produce machine-usable outputs (for example, procedure graphs, execution plans, and API call sequences), which prevents deeper automation at the server level and forces the client to remain a thin, non-adaptive UI.

Accordingly, there is a need for an improved computer-implemented system and server-side architecture that (1) converts heterogeneous, unstructured succession-related information into structured data, (2) integrates emotion analysis into the core control flow, (3) programmatically generates and uses prompt sentences for a generative AI model to derive both legal procedure plans and cross-platform account-operation procedures, and (4) executes those procedures automatically through an information communication network with reduced manual intervention. Such a system should improve the efficiency, robustness, and adaptability of inheritance and digital-asset processing on general-purpose computing hardware, while reducing redundant processing, API misconfigurations, and interaction overhead.

The specific processing by the specific processing unit 290 of the data processing device 12 in Application Example 2 is realized by the following means.

The present invention provides a server comprising a processor and a storage unit, the processor being configured to receive succession-related information from at least one source including a transferor of an asset and a transferee of the asset via a communication interface; to analyze the received succession-related information and user information by using a natural language processing technique to extract, as structured data stored in the storage unit, at least asset information, stakeholder information, procedure information, and emotion-related textual features; to generate, on the basis of the structured data and dialog history maintained in the storage unit, a machine-readable prompt sentence that is input to a generative information processing model executed locally or accessible via a network, and to obtain from the generative information processing model procedure step information and document information represented in a structured output format; to execute dialog-type information processing that presents the procedure step information in a staged manner to a terminal device and to update, in the storage unit, progress states associated with individual steps in response to inputs received from the terminal device; to perform emotion analysis processing on at least one of text data, voice data, and image data of a user so as to estimate an emotion state of the user, and to modify, according to the estimated emotion state, at least one of content and output format of the prompt sentence to be supplied to the generative information processing model, thereby generating support information in which at least one of explanation content, level of detail, and style of expression is dynamically adjusted; to store, in the storage unit, user identification information and authentication information associated with at least one information exchange service or social network service registered by the user; to determine, on the basis of external record information or input from a related person, a death state of at least one of the user and the transferor of the asset, and, when the death state satisfies a predetermined condition, to automatically execute, by using the stored user identification information and authentication information and by conforming to a communication rule of each information exchange service or social network service, an account operation process through an information communication network to perform at least one of a deletion process. a memorialization process, and a notification process for an account; and to manage execution results of the account operation process and of the succession procedures as progress information in the storage unit and to transmit the progress information to the terminal device via a notification function. This enables the server to improve computer functionality by transforming unstructured legal and emotional inputs into structured, machine-actionable representations, by coordinating generative AI model interactions through dynamically constructed prompt sentences that encode both legal context and emotion context, and by automatically orchestrating cross-platform account operations over the information communication network, thereby reducing manual intervention, lowering error rates in API-level operations, optimizing server-client interaction patterns, and increasing the reliability and scalability of inheritance and digital account end-of-life processing on general-purpose computing infrastructure.

The term “processor” refers to a hardware processing unit or a combination of hardware processing units, such as one or more central processing units or other programmable logic devices, that execute instructions to implement the functions described in this specification and claims.

The term “storage unit” refers to any non-transitory computer-readable medium, such as semiconductor memory, magnetic storage, or optical storage, that stores programs, structured data, dialog history, account information, and other information used by the processor.

The term “succession-related information” refers to information concerning transfer of rights, assets, or obligations from a transferor of an asset to a transferee of the asset, including identifiers of persons involved, attributes of assets, legal or administrative requirements, and relevant temporal information.

The term “transferor of an asset” refers to a person or entity from whom ownership, control, or other rights in one or more assets are to be transferred as part of a succession process.

The term “transferee of the asset” refers to a person or entity that is to receive ownership, control, or other rights in one or more assets from the transferor of the asset as part of a succession process.

The term “user information” refers to information associated with a human user or an operator of the system, including personal attributes, interaction history, preferences, and emotional expressions conveyed through text, voice, or images.

The term “natural language processing technique” refers to a computational method that processes human language data, including tokenization, syntactic analysis, semantic analysis, entity extraction, or sentiment analysis, to convert unstructured language data into structured representations.

The term “structured data” refers to data represented in a predefined, machine-readable format, such as records, fields, and typed attributes, which can be stored in data structures or databases and used for deterministic processing by the processor.

The term “asset information” refers to structured data describing one or more assets, including asset categories, identifiers, locations, values, and ownership relationships.

The term “stakeholder information” refers to structured data describing persons or entities that have a legal, financial, or practical interest in a succession process or a digital account, including roles such as transferor, transferee, heir, executor, or related party.

The term “procedure information” refers to structured data describing legal, administrative, or technical steps to be performed in relation to succession procedures or account operations, including step identifiers, dependencies, deadlines, and required documents.

The term “emotion information” refers to structured or semi-structured data representing emotional characteristics derived from user input, including emotion labels, sentiment scores, intensity values, and temporal associations.

The term “dialog history” refers to stored sequences of interactions between the system and a terminal device or user, including prompts, responses, timestamps, and metadata used for context-aware processing.

The term “prompt sentence” refers to a machine-readable instruction or query, composed in a natural or formal language, that is generated by the system and supplied as input to a generative information processing model to request generation of content or structured outputs.

The term “generative information processing model” refers to a trained computational model, such as a generative artificial intelligence model, that produces text, structured data, or other outputs in response to input data including prompt sentences.

The term “procedure step information” refers to structured data representing individual steps of a succession procedure, including step descriptions, ordering, prerequisites, and status indicators.

The term “document information” refers to structured or semi-structured representations of document content, layout, metadata, and associated case data used for generating or managing legal or administrative documents.

The term “dialog-type information processing” refers to processing in which the system presents information and obtains user input through iterative exchanges that simulate a conversational interaction, while maintaining context across multiple turns.

The term “progress state” refers to data indicating a current completion status of a step, document, or operation in a procedure, including states such as not started, in progress, completed, or failed.

The term “terminal device” refers to an endpoint computing device, such as a smartphone, tablet, or personal computer, that communicates with the server to present information to a user and to transmit user input.

The term “emotion analysis processing” refers to computational processing applied to user data such as text, voice, or image data to estimate an emotional state, including detection of categories such as sadness, anger, confusion, or calmness and corresponding intensity.

The term “emotion state” refers to an estimated emotional condition of a user at a point in time, represented by one or more emotion categories and associated parameters such as intensity or confidence values.

The term “support information” refers to output content generated by the system for assisting the user, including explanations, guidance messages, step-by-step instructions, or summaries, whose form or detail is adjusted based on context including the emotion state.

The term “explanation content” refers to textual or multimodal information that describes procedures, reasons, or implications of certain steps or operations to a user.

The term “level of detail” refers to the granularity or complexity of information presented to the user, including distinctions such as overview-level explanations and fine-grained stepwise instructions.

The term “style of expression” refers to linguistic or presentational characteristics of content, including tone, politeness level, technicality, and use of empathetic phrasing.

The term “information exchange service” refers to an online platform or system that enables users to send, receive, or share information with others, including messaging, email, or content-sharing services.

The term “social network service” refers to an online platform or system that enables users to establish social connections, share content, and interact with other users through profiles, posts, or messages.

The term “user identification information” refers to data that uniquely or semi-uniquely identifies a user within an information exchange service or social network service, including user names, account identifiers, or profile identifiers.

The term “authentication information” refers to data used to authenticate access to an account or service, including passwords, tokens, cryptographic credentials, or session identifiers.

The term “external record information” refers to data obtained from systems or sources external to the server, such as public registries, governmental databases, or third-party information providers, which can be used to determine a death state.

The term “related person” refers to a person or entity other than the user that is authorized or otherwise relevant to provide information regarding the user or transferor, including heirs, executors, legal representatives, or administrative personnel.

The term “death state” refers to a status value representing whether a person, such as the user or the transferor of an asset, is determined to be deceased, including additional qualifiers such as pending verification or confirmed.

The term “predetermined condition” refers to one or more criteria defined in advance and used by the system to decide whether a particular operation, such as initiating an account operation process, should be performed.

The term “account operation process” refers to a series of computer-implemented steps executed by the system to manipulate an account of an information exchange service or social network service, including deletion, memorialization, and notification.

The term “information communication network” refers to a communication infrastructure, such as the Internet or a private data network, that allows the server to exchange data with external services and terminal devices.

The term “communication rule” refers to a set of protocols, policies, and technical requirements defined by a service provider for exchanging data with its service, including application programming interfaces, authentication methods, and usage constraints.

The term “deletion process” refers to an account operation that removes or disables an account, or its associated data, in accordance with rules of an information exchange service or social network service.

The term “memorialization process” refers to an account operation that changes the state of an account to a special condition designated for deceased users, in which certain functions are restricted or altered for commemorative purposes.

The term “notification process” refers to an account operation in which a message indicating a death state or related information is transmitted to recipients such as contacts, followers, or administrators through an information exchange service or social network service.

The term “progress information” refers to data summarizing the current and historical execution states of succession procedures and account operation processes, including status codes, timestamps, and outcome indicators.

The term “notification unit” refers to a functional component or mechanism of the server configured to transmit information, such as progress information or alerts, to a terminal device or other destination over a communication channel.

In one embodiment, a server implements the claimed system by executing computer programs on one or more general-purpose processors and by storing data in one or more non-transitory storage units. The server is connected to at least one terminal and to a plurality of external network services via an information communication network. The server executes software modules including a succession information intake module, a natural language processing module, a generative AI interface module, a dialog management module, an emotion analysis module, an account management module, and a notification management module. The server stores data in structured form using a database management system and an object storage system.

The server uses, as example hardware, one or more multi-core central processing units, volatile memory, non-volatile memory, and network interface controllers. The server uses, as example software, an operating system, a relational or document-oriented database management system (for example, a SQL database), a message-queue system, and application frameworks for web communication. The terminal is, for example, a smartphone, a tablet, or a personal computer that runs an application or browser, which communicates with the server via an encrypted transport protocol.

The server stores succession-related information, user information, asset information, stakeholder information, and account information in normalized tables. The server represents each succession case as a record that includes a case identifier, pointers to person records for transferors and transferees, pointers to asset records, and pointers to digital account records. The server stores dialog history as sequences of turns, each turn including a user utterance, a system utterance, timestamps, and associated emotion state values.

The server receives succession-related information and user information from the terminal via an application programming interface. The server accepts both structured fields and unstructured natural language text. The server stores raw text and structured fields in the storage unit and then invokes the natural language processing module.

The server uses the natural language processing module to parse the received text. The server tokenizes the text, assigns part-of-speech tags, detects sentence boundaries, and performs dependency parsing to identify syntactic relations. The server applies named entity recognition to detect mentions of persons, organizations, locations, asset types, and dates. The server further executes domain-specific pattern matching on dependency graphs to detect phrases associated with inheritance roles, asset ownership, obligations, and deadlines.

The server converts the detected entities and relations into structured data objects. The server maps each detected person name to a person record, each asset mention to an asset record, and each legal or administrative activity phrase to a procedure template identifier. The server writes this structured data into the database, so that subsequent modules can operate on explicit data structures rather than on raw text. This structured representation enables deterministic algorithms to validate completeness, detect conflicts, and generate consistent prompts.

The server uses the generative AI interface module to construct a prompt sentence for a generative AI model. The server retrieves, from the database, the structured data objects and dialog history associated with a case. The server encodes them into a textual prompt that follows a defined template. The server, for example, generates a prompt sentence such as:
“Given the following succession case in Japan, list all legal and administrative steps required, with deadlines, required documents, and dependencies. Case: transferor: male, born 1945-01-01, died 2023-03-10; transferees: spouse and two children; assets: one house, two bank accounts, one securities account. Output a numbered list of steps and a separate list of required documents, both in Japanese and in a machine-readable bullet format.”

The server sends this prompt sentence to a generative AI model that runs either on the same server or on a remote inference service. In one embodiment, the generative AI model is a transformer-based neural network that processes sequences of tokens. The server uses a tokenizer to convert the prompt sentence into token identifiers, and the model processes these tokens through multiple stacked layers, each layer including multi-head self-attention blocks and feedforward blocks. The model has parameters including token embeddings, positional embeddings, attention weight matrices, and feedforward weight matrices. The server or an external training environment trains the model using a large corpus with supervised or instruction-tuned objectives.

The server, during training, minimizes a loss function such as cross-entropy between predicted tokens and target tokens for instruction completion tasks. The training environment updates the model parameters using gradient descent with backpropagation, adjusting attention weights and feedforward weights to better generate structured step lists, document outlines, and procedural explanations. The server, at inference time, uses the fixed trained parameters to compute next-token probabilities and to generate sequences according to decoding strategies such as greedy decoding, beam search, or temperature-controlled sampling.

The server receives from the generative AI model an output sequence representing procedure step information and document information. The server parses the output according to predefined markers in the prompt. For example, the server identifies headings such as “Steps:” and “Documents:” and splits the output accordingly. The server constructs internal data structures where each step is a record including a step identifier, a textual description, a due date or relative deadline, and a pointer to required documents. The server similarly constructs document records containing document titles, required fields, signatories, and references to templates.

The server uses the dialog management module to present these steps and documents to the user via the terminal. The server represents the workflow as a directed acyclic graph, where each node is a step and edges represent prerequisites. The server stores this graph in the database. The server serializes the graph into a compact format that the terminal can render as a checklist or timeline. The server determines which steps can be executed in parallel and which must be sequential, reducing unnecessary round-trips and repeatedly asking the user for already-known information.

The server analyzes user emotions using the emotion analysis module. The server receives text, audio, or image signals from the terminal. The server extracts features from text such as token n-grams, sentiment-bearing terms, and syntactic structures. The server passes those features to a classifier trained to output emotion labels and intensity scores. The classifier can be implemented as a neural network with an embedding layer, one or more recurrent or transformer layers, and a classification head.

The server extracts audio features such as Mel-frequency cepstral coefficients, pitch contours, and energy statistics from voice data. The server feeds these features into a neural network trained to distinguish emotional states such as sadness, anger, confusion, and calm. The server extracts facial features from images or video frames using a convolutional network, and maps those features to emotion labels. The server fuses the modalities by computing a weighted combination of textual, acoustic, and visual emotion scores using a rule-based or learned fusion network.

The server stores the resulting emotion state, including labels and intensities, alongside the dialog history. The server compares the current emotion state to thresholds. For example, if sadness intensity is above a first threshold, the server reduces information density and increases empathetic phrasing. If confusion intensity is above a second threshold, the server increases granularity of explanation and includes explicit justifications of each recommended step.

The server, based on these emotion states, modifies subsequent prompt sentences provided to the generative AI model. The server appends explicit instructions to the prompt, such as:
“The user is highly stressed and grieving. Simplify the explanation, avoid legal jargon, and limit each answer to three concise bullet points.”
   or:
“The user is confused and has requested detailed instructions. Provide step-by-step guidance with numbered substeps, and include short reasons for why each step is necessary.”

By embedding emotion-derived constraints into prompt sentences, the server causes the generative AI model to generate responses with controlled style and structure. This control leads to fewer follow-up clarification questions from the user, reducing network traffic between the server and terminal and reducing computational load on both the generative AI model and the dialog management logic.

The server also manages digital accounts on information exchange services and social network services. The server stores, for each account, user identification information, authentication information, and desired post-mortem actions. The server encodes each account as an object that includes fields for platform type, token expiration times, required API endpoints, and terms-of-service constraints. The server periodically validates token freshness and updates status flags.

The server determines a death state of a user or transferor based on external record information or input from a related person. The server, for example, queries an external registry via an application programming interface using structured search criteria derived from stored personal data. The server may also ask the generative AI model to interpret ambiguous responses by including a prompt sentence such as:
“Given the following registry response, determine whether the person with name X and date of birth Y is likely deceased, and explain your reasoning in a single sentence.”

The server receives a classification and explanation from the generative AI model and applies a deterministic rule to accept or reject the death state update. This combination of neural and rule-based processing is non-conventional relative to manual review and allows the server to process large volumes of cases more quickly than a human-centric process while maintaining auditable decision criteria.

The server, once the death state meets a predetermined condition, automatically orchestrates account operations. The server generates a prompt sentence for the generative AI model that encodes platform types, available credentials, death state, user preferences, and emotion state. An example prompt is:
“Generate a sequence of API calls for the following platforms, including the HTTP method, endpoint path, required headers, and JSON bodies, to delete or memorialize the user accounts after death. Platforms: generic social service A (delete account), generic social service B (memorialize account). The user's relatives are grieving, so propose a short notification message expressing condolences in simple language.”

The server receives a structured description of required calls and message templates. The server validates each proposed call against a stored schema that represents communication rules for each platform. The server then uses an HTTP client library to transmit authenticated requests to each platform, logs the responses, and updates account status fields. The server thereby controls external computing equipment (remote servers of the services) in a coordinated manner. This control is not achievable by a user performing isolated manual operations, and it reduces inconsistency and error caused by misunderstanding of platform-specific requirements.

The server transmits progress information to the terminal. The server maintains, for each step and account operation, status, timestamps, error codes, and retry counts. The server formats these records as compact messages and pushes them via a notification mechanism. The terminal receives these messages and updates graphical indicators such as progress bars and status icons, enabling the user to see real-time results of automated operations.

This architecture yields technical effects beyond mere automation of human clerical work. Because the server converts unstructured natural language and multimedia input into structured data and emotion states that directly drive prompt composition and workflow generation, the server reduces computational waste created by repeated, unfocused generative calls. The modular, structured pipeline minimizes the need for redundant parsing and interpretation on the client side, which reduces bandwidth consumption and latency.

The server's use of a trained, transformer-based generative model, together with emotion-aware prompt sentences and validation logic, enables the server to output machine-usable workflow graphs and API call sequences. Human operators cannot practically design such sequences in real time at the same level of consistency or scale, especially when adjusting phrasing and step ordering according to emotion states. The server, therefore, improves computation by automatically adapting its internal decision rules and output structures to user state, which leads to fewer errors, fewer failed account operations, and fewer repeated requests.

In one variation, the server uses a different neural architecture, such as an encoder-decoder sequence model with attention, but maintains the same overall flow of tokenization, embedding, attention-based contextualization, and decoding. In another variation, the server combines the generative model with a rules engine that encodes legal constraints or platform terms of service, and uses the generative output as a suggestion that is automatically checked and possibly corrected by deterministic logic. In yet another variation, the server executes emotion analysis solely on textual data when audio or video are unavailable, and the server uses a simpler classifier model, such as a logistic regression or support vector machine operating on embedding vectors.

The server may also employ data augmentation during training of emotion classifiers or generative control tokens. The server can, for example, generate synthetic utterances expressing grief or confusion and label them accordingly, thereby improving robustness of emotion recognition. The server can adjust loss functions during training to penalize misclassification of high-intensity emotions more heavily than of low-intensity emotions, so that the system is particularly sensitive to states that require careful interaction changes.

The server, by maintaining structured representations of procedures and account operations, can reuse and cache partial results. For example, once the server has generated a base succession procedure plan for a particular jurisdiction and asset pattern, the server can store that plan and then use a smaller, incremental prompt to adapt it to a new user case. This reuse reduces the number of tokens processed by the generative model, thereby reducing computation time and energy consumption.

The terminal presents user interfaces that are adapted based on metadata from the server. If the server marks a step as emotionally sensitive (for example, account deletion for a deceased person), the terminal can use more deliberate confirmation dialogs. If the server marks a step as urgent from a legal deadline perspective, the terminal can highlight this with color and ordering. This separation of concern between server computation and terminal presentation allows the server to manage complex internal logic while preserving a simple terminal implementation.

The user interacts with the system by entering information, reviewing generated procedures and documents, and confirming or adjusting digital account operations. The user can, for instance, input a natural language sentence such as:
“My father passed away last month, he owned a house and two bank accounts, and I want to know what documents I need to prepare.”

The server interprets this utterance, extracts asset and relation information, generates a legally appropriate step plan and document list, and responds with a concise, emotion-aware explanation. The user does not need to understand legal terminology or platform-specific API details. The server thereby implements a technical mediation that translates between heterogeneous human expressions and unified machine-level operations.

Additional embodiments can vary according to hardware configuration, models, and protocols. The server can be implemented as a cloud-based cluster with horizontally scaled instances, each instance handling a subset of succession cases and using a shared model serving platform. The generative model can be deployed in a model server that serves multiple applications, with the present server providing specialized prompt construction and response parsing. The emotion analysis module can be integrated with third-party emotion analysis services, or implemented purely in-house.

In each of these embodiments, the core technical features remain: the server transforms unstructured and emotionally laden succession-related inputs into structured workflow and account-operation representations via natural language processing, emotion recognition, and generative modeling; the server uses these representations to automatically control communication with external digital services according to platform communication rules; and the server optimizes internal data structures and flows to improve processing speed, accuracy, and resource usage compared to manual or naive automated approaches.

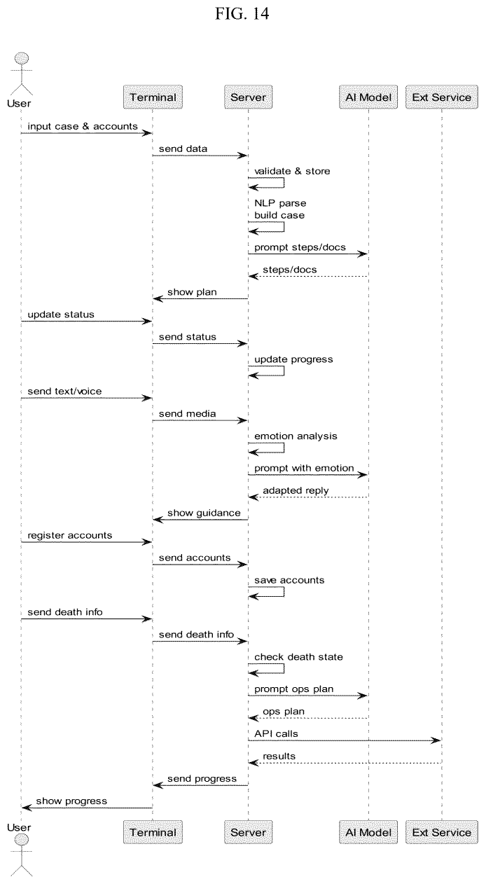

The following describes the processing flow using FIG. 14.

### Step 1:

User operates the terminal to input succession-related information and digital account information.

User enters, as input, text fields such as names of transferors and transferees, dates of birth and death, relationships, descriptions of assets (for example, real estate, financial accounts), and narrative explanations in natural language.

User also enters, as input, identifiers and preferences for information exchange services and social network services, such as account names, profile URLs, and desired post-mortem actions (delete, memorialize, notify).

Terminal receives these inputs, converts them into a structured JSON format, attaches user authentication data, and outputs a serialized request message to the server over an encrypted network connection.

### Step 2:

Server receives the request message from the terminal and performs input validation.

Server takes, as input, the JSON payload and uploaded documents, and checks field types, required keys, and basic consistency constraints (for example, valid date formats, non-empty names).

Server, based on this input, performs data parsing and type conversion, and outputs normalized internal data objects in memory representing persons, assets, relationships, and accounts. Server then writes these internal data objects and raw text fields into a database and an object storage, and outputs persistent identifiers such as case IDs and user IDs.

### Step 3:

Server executes natural language processing on the received free-text descriptions.

Server uses, as input, the stored natural language utterances and narrative fields associated with a case.

Server tokenizes the text, applies part-of-speech tagging, and performs dependency parsing to compute syntactic relations, and applies named entity recognition to detect names, asset types, locations, and dates.

Server then performs pattern matching on dependency graphs to detect role expressions (for example, “my father,” “my sister”), asset ownership phrases, and temporal constraints.

Server outputs structured entities and relations, including asset information, stakeholder information, and candidate procedure information, and stores these as structured records linked to the case.

### Step 4:

Server extracts and aggregates structured data to form an internal case representation.

Server uses, as input, the structured entities and relations from the natural language processing module and the validated fields from the initial request.

Server merges these data sources by matching person names, resolving duplicate records, and reconciling asset mentions with explicit asset entries.

Server outputs a consolidated case representation, for example, a data structure that includes lists of transferors, transferees, assets, and preliminary procedure requirements, which will be used for prompt construction.

### Step 5:

Server constructs a first prompt sentence for the generative AI model to generate a succession procedure plan.

Server uses, as input, the consolidated case representation and dialog history for the user.

Server formats these data into a textual template that encodes jurisdiction, roles, asset types, and desired output format.

Server explicitly inserts markers such as “Steps:” and “Documents:” to facilitate later parsing. Server outputs a complete prompt sentence such as:
“Given the following succession case, list all legal and administrative steps required, with deadlines and required documents, and output them in a numbered format suitable for machine parsing. Case: . . . ”.

### Step 6:

Server sends the prompt sentence to the generative AI model and receives a model output.

Server uses, as input, the constructed prompt sentence and any additional control parameters such as temperature and maximum token length.

Server transmits this input to the generative AI model via a model interface and waits for an output token sequence.

Server decodes the token sequence to text and outputs a response text that includes procedure step information and document information according to the requested format.

### Step 7:

Server parses the generative AI model output into structured procedure steps and document definitions.

Server uses, as input, the raw text generated by the generative AI model.

Server scans for predefined markers (for example, headings, numbering patterns) and splits the text into sections for steps and documents.

Server converts each step description into a record with fields such as step ID, description, relative deadline, and associated document IDs.

Server converts each document description into a record with fields such as title, purpose, and required data fields.

Server outputs structured procedure step information and document information and stores them in the database as a workflow graph.

### Step 8:

Server prepares a response containing the procedure plan for display on the terminal.

Server uses, as input, the structured step records and document records linked to the case.

Server filters steps based on initial priority or deadlines, orders them according to dependencies, and generates a simplified summary for user presentation.

Server outputs a JSON representation of the procedure plan, including steps, dependencies, and document metadata, and sends this to the terminal.

### Step 9:

Terminal receives the procedure plan and renders it to the user.

Terminal uses, as input, the JSON representation of steps and documents from the server.

Terminal maps each step to user-interface elements such as list entries and progress indicators, and associates actions such as “mark complete” or “view document details.”

Terminal outputs a visual display that shows the procedure flow and allows the user to interact with individual steps.

### Step 10:

User reviews the procedure plan and updates step statuses.

User uses, as input, the displayed step list and document descriptions to understand upcoming actions.

User selects actions on the terminal such as “start this step,” “complete this step,” or “request detailed explanation.”

Terminal captures these interactions, generates corresponding status update messages, and outputs them to the server as structured events.

### Step 11:

Server updates procedure progress and may generate additional guidance.

Server uses, as input, the status update events from the terminal.

Server updates the corresponding step records in the database (for example, changing status from “not started” to “in progress” or “completed”) and recalculates overall progress metrics.

Server may construct a secondary prompt sentence requesting a short summary or additional detail for a specific step, send it to the generative AI model, and receive and parse the result.

Server outputs updated progress information and optional additional explanations to the terminal.

### Step 12:

Terminal captures multimodal user input for emotion analysis.

Terminal uses, as input, user interactions during dialogs, including text messages, optional voice recordings, and optional facial images or video frames.

Terminal digitizes audio and video signals, compresses them, and attaches metadata such as timestamps and context identifiers.

Terminal outputs this multimodal data as a request to the server for emotion analysis.

### Step 13:

Server performs emotion analysis on user input.

Server uses, as input, textual utterances, audio features, and image frames received from the terminal.

Server extracts textual features such as token embeddings and sentiment-bearing phrases, extracts audio features such as spectral coefficients and pitch contours, and extracts visual features such as facial landmarks.

Server feeds these feature vectors into one or more trained classifiers that output emotion labels and intensity scores.

Server outputs an emotion state record containing labels (for example, sadness, confusion) and numeric scores, and associates this record with the current dialog state.

### Step 14:

Server adjusts subsequent prompt sentences and support content based on the emotion state.

Server uses, as input, the emotion state record and the current case and dialog context.

Server applies rules or mapping functions that, for a given emotion profile, select an explanation style (for example, more empathetic, more detailed, or more concise) and desired output structure.

Server then modifies the next prompt sentence for the generative AI model by appending explicit instructions, such as “simplify language” or “provide step-by-step details,” and outputs this adjusted prompt sentence.

Server sends the adjusted prompt sentence to the generative AI model, receives a new response tailored to the emotion state, and outputs adapted support information back to the terminal.

### Step 15:

User registers digital accounts and post-mortem preferences on the terminal.

User uses, as input, forms that request platform types, account identifiers, and preferred actions after death.

User selects options such as “delete account after confirmation of death,” “convert account to memorial state,” or “send death notification message to followers.”

Terminal structures these selections and identifiers into account registration messages and outputs them to the server.

### Step 16:

Server stores and maintains digital account information.

Server uses, as input, the account registration messages including service types, user identification information, authentication information, and preference flags.

Server encrypts sensitive fields, assigns internal account IDs, and stores the records in tables for digital accounts.

Server also stores default or user-provided notification messages associated with each account.

Server outputs confirmation acknowledgments and maintains an index for efficient lookup of accounts by user and platform type.

### Step 17:

Server determines the death state of the user or transferor.

Server uses, as input, external record responses (for example, from public registries) and confirmation inputs from related persons submitted through the terminal.

Server parses external records, compares identifiers such as name and date of birth, and may optionally construct a prompt sentence to the generative AI model requesting an interpretation of ambiguous records.

Server applies deterministic rules to combine evidence and sets the death state field to “confirmed” or another value.

Server outputs the updated death state status and logs the source and time of the determination.

### Step 18:

Server plans account operations based on service rules and user preferences.

Server uses, as input, the confirmed death state, stored account records, and service-specific communication rules.

Server generates a prompt sentence for the generative AI model that encodes which platforms must receive deletions, which must receive memorialization requests, and what notification text style is appropriate.

Server sends this prompt sentence to the generative AI model and receives a response describing recommended API call sequences and notification message bodies.

Server cross-checks the recommended calls against stored schemas, adjusts them if necessary, and outputs an internal execution plan listing platform endpoints, HTTP methods, authentication methods, and payload templates.

### Step 19:

Server executes account operation processes over the information communication network.

Server uses, as input, the internal execution plan and stored authentication information for each account.

Server fills in dynamic values such as user IDs and message texts in the payload templates and sends authenticated HTTP requests to each external service's API endpoint.

Server receives responses containing status codes and result messages, analyzes them for success or error, and outputs updated account status records (for example, “deletion requested,” “deleted,” “memorialized,” or “notification sent”) stored in the database.

### Step 20:

Server manages and communicates progress information to the terminal.

Server uses, as input, the current status of procedure steps, document generation tasks, emotion-adapted support interactions, and account operation processes.

Server aggregates these statuses into a unified progress model that includes timestamps, completion percentages, error flags, and recommended next actions.

Server serializes this progress information into a compact format and pushes it via a notification mechanism or responds to terminal polling requests.

Server outputs this progress data to the terminal, enabling consistent, up-to-date visualization.

### Step 21:

Terminal displays progress information and results to the user.

Terminal uses, as input, the aggregated progress data sent by the server.

Terminal updates graphical elements such as progress bars, checklists, and status labels, and may display confirmation messages for completed account operations and succession steps.

Terminal outputs a user interface that allows the user to verify completed operations, review generated documents, and decide whether to proceed with remaining tasks or close the case.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14.

Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

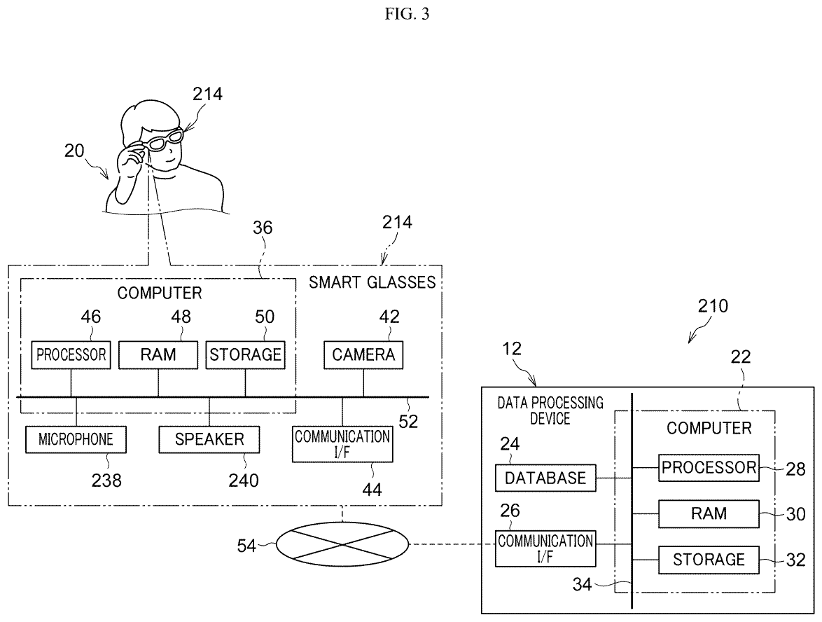

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

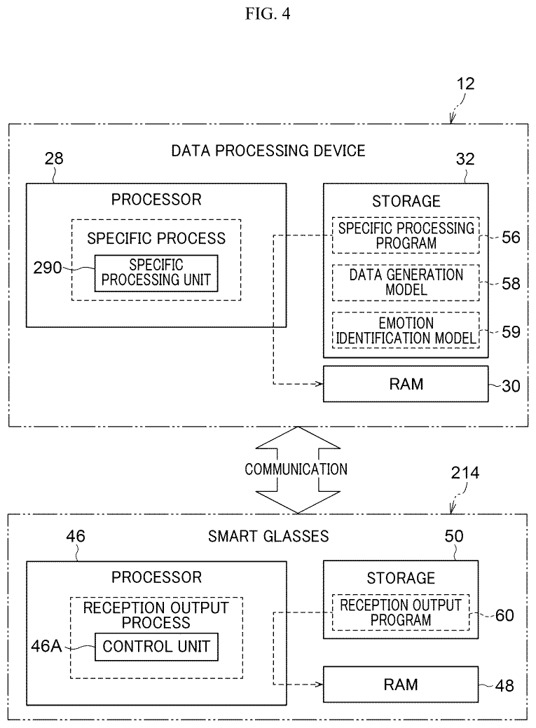

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc.

The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

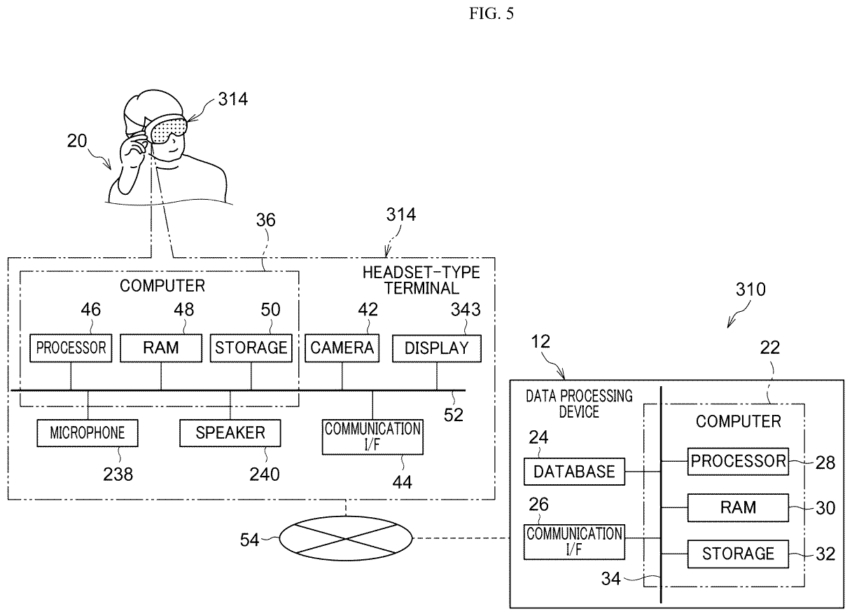

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

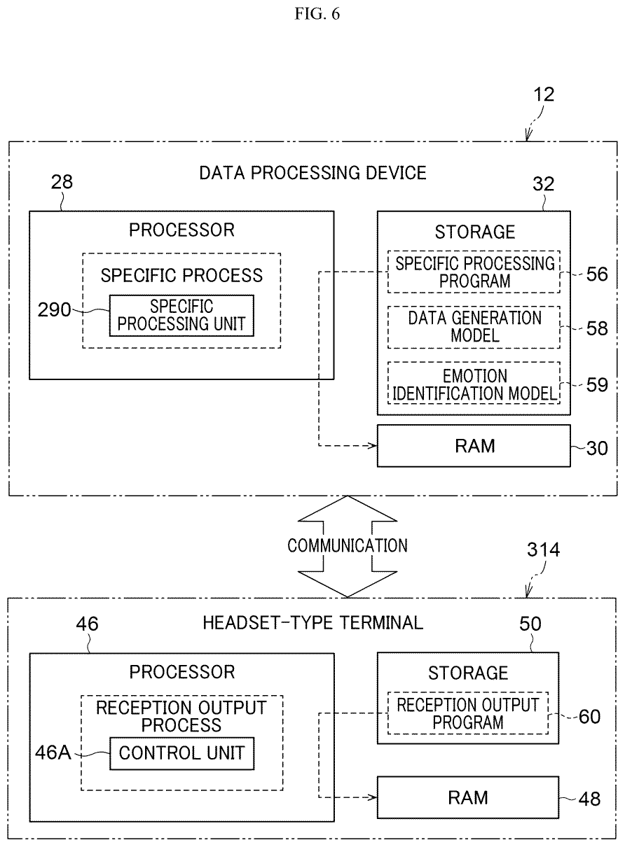

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

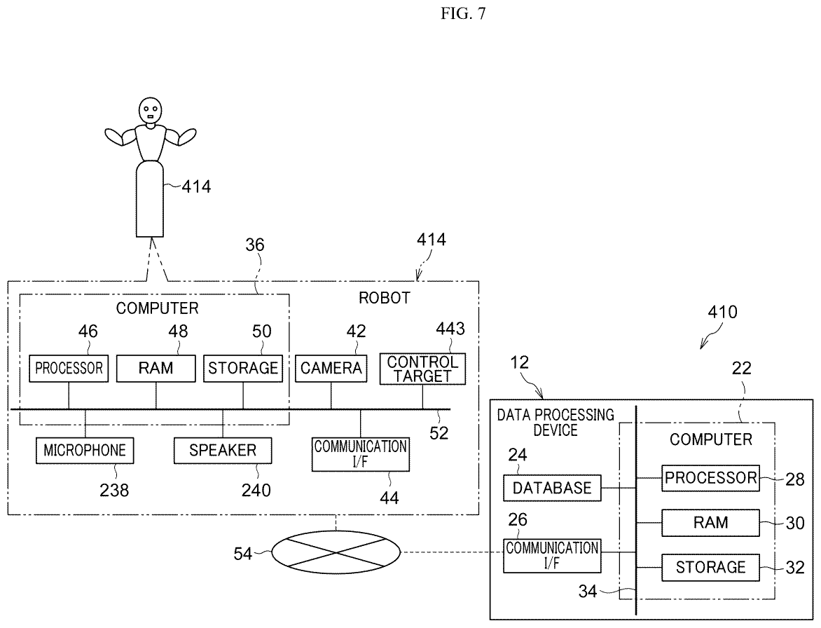

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

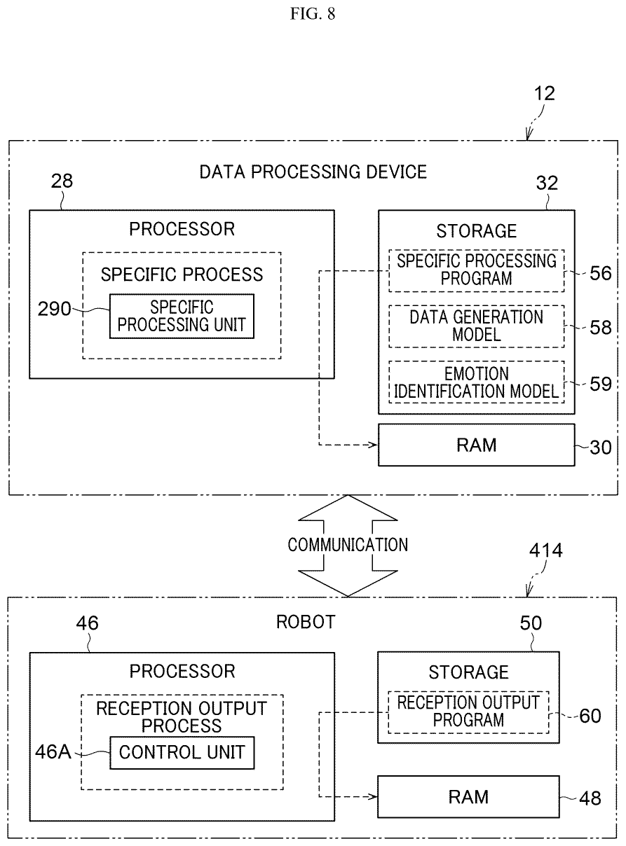

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

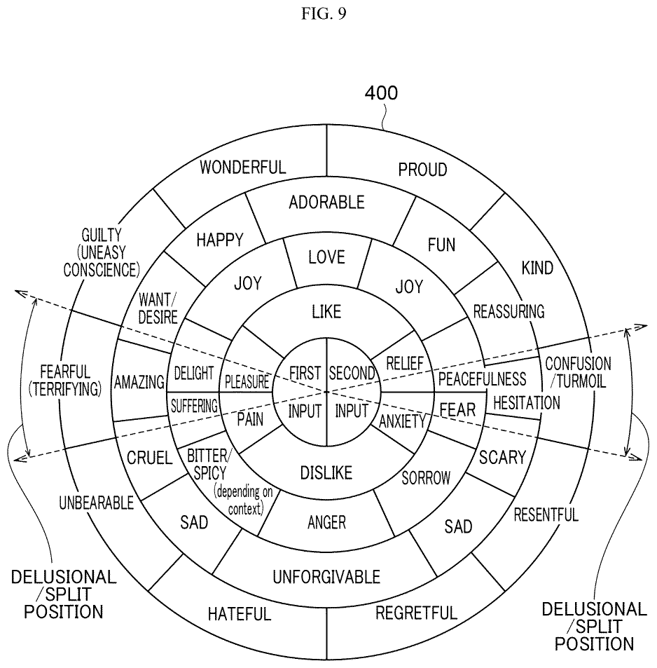

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

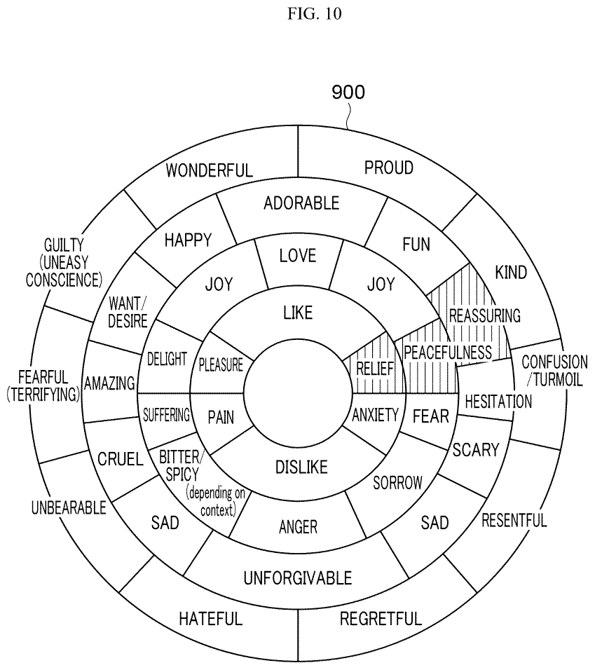

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, via a terminal, succession-related information regarding property succession from a transferor and a successor, and store, in a storage device, the succession-related information including attribute information of the transferor, attribute information of the successor, attribute information of property, and attribute information of procedural preferences; and
acquire, from the stored succession-related information, information input in natural language and structured information, and analyze the acquired information by using a natural language processing technique to identify attributes of the transferor and the successor, types and valuations of the property, and candidate procedures required for the property succession; and automatically generate a prompt sentence to be input to a generative AI model, the prompt sentence being structured character information including a role instruction portion, a task instruction portion, a case summary portion, and an output format instruction portion, on the basis of the identified candidate procedures and the acquired succession-related information; and input the automatically generated prompt sentence to the generative AI model and obtain, from the generative AI model, an analysis result including a list of procedures required for the property succession, a list of documents required for each procedure, and a document draft for each document; and
compare the obtained analysis result with reference information stored in the storage device, associate each procedure in the analysis result with an internal procedure type, associate each document with the corresponding procedure type and the succession-related information, and register the associated procedures and documents in the storage device; and
generate electronic document data by replacing predetermined regions of template data corresponding to a predetermined document format with the registered document draft for each document and the succession-related information, and output the electronic document data as a file in a viewing format; and
electronically transmit, via a communication network, the electronic document data to an external organization on the basis of the electronic document data and destination information regarding the external organization specified according to the procedure type, and update a progress state of each procedure according to a transmission result; and
notify the updated progress state and information regarding the electronic document data to the terminal so as to cause the terminal to generate display information that enables confirmation of a progress status of the procedures related to the property succession and acquisition of the electronic document data.

### Supplementary 2

The system according to supplementary 1,
wherein the processor is configured to
receive, from the terminal, additional input or correction input for the succession-related information, regenerate the prompt sentence on the basis of the additional input or the correction input, execute re-analysis by the generative AI model to update the list of procedures and the document drafts, and dynamically update the electronic document data and the progress state on the basis of an updated analysis result.

### Supplementary 3

The system according to supplementary 1,
wherein the processor is configured to
generate a prompt sentence to be input to the generative AI model on the basis of the succession-related information and the progress state in order to perform end-of-life support in a social network service, and transmit, to a management apparatus of the social network service, guidance information or notification information regarding end-of-life generated on the basis of the prompt sentence, thereby causing processing of user information or notification of death in the social network service.

### Application Example 1

### Supplementary 1

A system comprising a processor,
wherein the processor is configured to
receive succession-related information from a transferor and a successor, analyze the succession-related information by using a natural language processing technique, construct, based on a result of the analyzing, a prompt sentence to be input to a generative information processing model, and transmit the prompt sentence to the generative information processing model,
calculate, based on a response obtained from the generative information processing model, payment plan information including payment items and payment amounts required for a succession procedure,
convert the payment plan information into display data for a display terminal and output the display data so as to visualize procedure contents and payment contents related to the succession, transmit, based on the payment plan information, an electronic payment request to a transaction processing apparatus via a financial transaction communication interface and execute payment processing related to the succession procedure, and
notify the transferor and the successor of payment completion information based on a result of the payment processing.

### Supplementary 2

The system according to supplementary 1,
wherein the processor is configured to
store the succession-related information, the payment plan information, and a result of the payment processing in a storage device in association with identification information, and manage, in an integrated manner, progress of procedures and payments related to the succession based on stored information.

### Supplementary 3

The system according to supplementary 1,
wherein the processor is configured to
transmit, to the generative information processing model, a prompt sentence including input data containing the succession-related information and constraint conditions specifying an output format, obtain the payment plan information in a machine-readable format from the generative information processing model, and generate the payment items and the payment amounts as structured data based on the machine-readable format.

### Example 2

### Supplementary 1

A system comprising a processor and a storage device and a communication interface,
wherein the processor is configured to
receive, from a terminal, inheritance-related information including information of a transferor and information of a transferee, and analyze the received inheritance-related information by using a natural language processing technique,
generate and input a prompt sentence to a generative AI model on the basis of an analysis result and the inheritance-related information, and obtain, from the generative AI model, natural language text including contents of required inheritance-related procedures and documents, acquire, on the basis of the inheritance-related information, identification information related to the transferor that is stored in the storage device, and, by using the identification information, specify, via a communication interface of an external information processing service, a plurality of user account candidates related to the transferor,
present the plurality of user account candidates to the terminal, and, on the basis of a selection result of user accounts received from the terminal and processing contents designated for each of the user accounts, automatically transmit, via the communication interface of the external information processing service, a deletion request or a death notification request for the user accounts,
input, to the generative AI model, a prompt sentence from a user and context information including information of the specified user accounts, and obtain, from the generative AI model, an explanatory text of procedures corresponding to the prompt sentence and procedure information indicating processing steps for the user accounts,
analyze the obtained procedure information to classify processing into processing executable automatically and processing requiring manual execution by the user, automatically execute the processing executable automatically via the communication interface of the external information processing service, and visualize and present, to the terminal, the processing requiring manual execution by the user, and
record, in the storage device, progress states and completion states of respective processing on the basis of processing result information acquired from the external information processing service, and transmit, to the terminal, notification information indicating the progress states and the completion states.

### Supplementary 2

The system according to supplementary 1,
wherein the processor is configured to
convert inheritance-related procedures and tasks concerning property succession into task information as an electronic workflow stored in the storage device, manage the task information in an integrated manner in association with the procedure information obtained from the generative AI model, schedule and execute automatic processing tasks on the basis of the task information, and generate reminder notifications to the user according to deadline information for manual processing tasks so as to reduce a burden on the transferor and the transferee.

### Supplementary 3

The system according to supplementary 1,
wherein the processor is configured to
input a prompt sentence to the generative AI model to generate, for each social network type information providing service, an explanatory text and procedure information for a deletion procedure and a death notification procedure related to the social network type information providing service, present the explanatory text to the terminal, and, on the basis of the procedure information, automatically execute deletion or death notification of user accounts on the social network type information providing service via a communication interface of the social network type information providing service.

### Application Example 2

### Supplementary 1

A system comprising a processor,
wherein the processor is configured to
receive succession-related information from at least one source including a transferor of an asset and a transferee of the asset,
analyze received succession-related information and user information by using a natural language processing technique, and extract, as structured data, at least asset information, stakeholder information, procedure information, and emotion information,
generate a prompt sentence to be input to a generative information processing model on the basis of the structured data and dialog history, input the prompt sentence to the generative information processing model, and automatically generate procedure step information and document information related to succession procedures,
execute dialog-type information processing that presents the procedure step information related to the succession procedures in a staged manner, and update a progress state of the procedure step information in response to input from a terminal device,
perform emotion analysis processing on at least one of text data, voice data, and image data of a user, and estimate an emotion state of the user,
change, according to the estimated emotion state, at least one of content and output format of the prompt sentence to be input to the generative information processing model, and generate support information in which at least one of explanation content, level of detail, and style of expression is dynamically adjusted,
store, in a storage unit, user identification information and authentication information associated with at least one information exchange service or social network service registered by the user, determine a death state of at least one of the user and the transferor of the asset on the basis of external record information or input from a related person, and, when the death state satisfies a predetermined condition, automatically execute, by using the stored user identification information and authentication information, an account operation process through an information communication network in conformity with a communication rule of each of the at least one information exchange service or social network service, and perform at least one of a deletion process, a memorialization process, and a notification process for an account, and
manage execution results of the account operation process and the succession procedures as progress information and transmit the progress information to the terminal device via a notification unit.

### Supplementary 2

The system according to supplementary 1,
wherein the processor is configured to
change at least one of proposal content, processing order, and processing amount of the succession procedures on the basis of a result of the emotion analysis processing, and perform at least one of simplification, postponement, and resumption proposal of the succession procedures for reduction of a burden on the user.

### Supplementary 3

The system according to supplementary 1,
wherein the processor is configured to
generate the prompt sentence to be input to the generative information processing model according to at least a type of each registered information exchange service or social network service, a communication rule of each service, the death state of the user, and the emotion state of the user, automatically generate, on the basis of the prompt sentence, at least one of message content and execution procedure for account deletion, memorialization, or death notification for each service, and execute the account operation process on the basis of the automatically generated message content and execution procedure.

What is claimed is:

1. A system comprising:
circuitry configured to
receive, via a packet-switched network, a plurality of heterogeneous data records from a terminal device, each heterogeneous data record comprising at least one natural language character sequence and a plurality of structured attribute fields associated with entity identifier data;
store the plurality of heterogeneous data records in a storage device by indexing each heterogeneous data record with a case identifier;
apply a natural language processing operation to the at least one natural language character sequence to extract a set of structured feature data comprising entity attribute pairs and candidate classification labels with associated confidence score values;
determine, based on the set of structured feature data and a set of rule condition definitions stored in the storage device, a list of candidate procedure type codes satisfying respective rule condition predicates;
generate a structured input sequence for a generative neural network model by inserting values from the structured attribute fields, the set of structured feature data, and the list of candidate procedure type codes into a prompt template data structure comprising a role instruction portion, a task instruction portion, a case summary portion, and an output format specification portion;
input the structured input sequence to the generative neural network model to obtain output character sequence data;
parse the output character sequence data according to the output format specification portion to extract a plurality of structured result objects comprising procedure list data, document list data, and draft text data;
map the plurality of structured result objects to internal data type codes and populate electronic document template data with the draft text data and the structured attribute fields to generate electronic document data; and
transmit, via the packet-switched network, the electronic document data and a progress state indicator to the terminal device for rendering on a display of the terminal device.

2. The system according to claim 1, wherein the natural language processing operation comprises tokenizing the at least one natural language character sequence into a plurality of token units, applying a named entity recognition model to identify entity spans within the plurality of token units, and mapping each identified entity span to a candidate attribute field based on a semantic similarity score computed between the entity span and a set of predefined attribute labels.

3. The system according to claim 2, wherein the named entity recognition model identifies entity types comprising person name entities, location entities, temporal entities, and monetary value entities, and wherein the semantic similarity score is computed using a vector representation of each entity span and a vector representation of each predefined attribute label.

4. The system according to claim 3, wherein the plurality of heterogeneous data records comprise succession case description data representing a natural language account of a property transfer scenario, transferor attribute data and successor attribute data representing identification and relationship characteristics of parties, and asset attribute data representing classification and valuation characteristics of property items subject to a succession process.

5. The system according to claim 4, wherein the list of candidate procedure type codes comprises legal filing procedure codes, tax reporting procedure codes, and institutional notification procedure codes determined based on asset classification values and party relationship values extracted from the set of structured feature data.

6. The system according to claim 1, wherein the generative neural network model comprises a transformer-based language model having an embedding layer, a plurality of self-attention layers that compute attention weight distributions over input token representations, and a feed-forward output layer that generates a probability distribution over a vocabulary of token identifiers.

7. The system according to claim 6, wherein the prompt template data structure is stored in the storage device and comprises placeholder markers that are replaced by the circuitry with case-specific values during generation of the structured input sequence, and wherein the output format specification portion defines labeled section delimiters that the generative neural network model is instructed to follow in generating the output character sequence data.

8. The system according to claim 7, wherein parsing the output character sequence data comprises detecting labeled section delimiters within the output character sequence data, segmenting the output character sequence data into a procedure section, a document section, and a draft section based on the detected delimiters, and extracting individual items from each section using pattern matching operations.

9. The system according to claim 8, wherein each structured result object in the procedure list data comprises a procedure name, a procedure type code, and a set of required action steps, and wherein each structured result object in the document list data comprises a document name, a document type code, and a list of required attribute fields to be populated.

10. The system according to claim 1, wherein the circuitry is further configured to:
populate a plurality of electronic document templates by inserting the draft text data into body field regions of the templates and inserting corresponding structured attribute field values into header field regions of the templates to generate a plurality of electronic document data items;
and store each electronic document data item in the storage device with an association to the case identifier and a document status indicator.

11. The system according to claim 10, wherein the circuitry is further configured to transmit, via the packet-switched network, at least one electronic document data item to an external system interface address associated with an institutional recipient, and update the document status indicator in the storage device to reflect a transmitted status.

12. The system according to claim 11, wherein the external system interface address corresponds to a governmental filing system or a financial institution system, and wherein the circuitry is further configured to receive, via the packet-switched network, an acknowledgment response from the external system and update the progress state indicator based on the acknowledgment response.

13. The system according to claim 1, wherein the circuitry is further configured to:
receive, via the packet-switched network, account credential data and service provider identifier data from the terminal device;
generate a second structured input sequence for the generative neural network model, the second structured input sequence encoding the service provider identifier data and an instruction character sequence specifying generation of an end-of-life account processing request; and
input the second structured input sequence to the generative neural network model to obtain second output character sequence data comprising a formatted notification message or a formatted deletion request directed to the service provider.

14. The system according to claim 13, wherein the service provider identifier data identifies a social networking service provider, and wherein the formatted notification message comprises a death notification message or the formatted deletion request comprises an account deactivation request conforming to a provider-specific format template retrieved from the storage device.

15. The system according to claim 14, wherein the circuitry is further configured to transmit, via the packet-switched network, the formatted notification message or the formatted deletion request to a service provider interface endpoint, and record a transmission status in the storage device associated with the case identifier and the service provider identifier data.

16. The system according to claim 1, wherein the circuitry is further configured to:
receive, via the packet-switched network, a modified natural language character sequence from the terminal device representing revised case description data;
generate a revised structured input sequence by inserting the modified natural language character sequence into the prompt template data structure; and
input the revised structured input sequence to the generative neural network model to obtain revised output character sequence data, and update the plurality of structured result objects based on the revised output character sequence data.

17. The system according to claim 16, wherein the circuitry is further configured to store, in the storage device, version association data linking the revised output character sequence data with the modified natural language character sequence and the case identifier, thereby maintaining a traceable history of generated outputs and corresponding input modifications.

18. A system comprising:
circuitry configured to
receive, via a packet-switched network, a plurality of heterogeneous data records from a terminal device, each heterogeneous data record comprising a natural language character sequence and structured attribute fields associated with entity identifier data;
store the plurality of heterogeneous data records in a storage device indexed by a case identifier;
apply a natural language processing operation comprising tokenization, named entity recognition, and semantic similarity computation to the natural language character sequence to extract structured feature data comprising entity attribute pairs, candidate classification labels, and confidence score values;
determine, based on the structured feature data and rule condition definitions stored in the storage device, a list of candidate procedure type codes;
generate a structured input sequence for a generative neural network model by populating a prompt template data structure with the structured attribute fields, the structured feature data, and the list of candidate procedure type codes, the prompt template data structure comprising a role instruction portion, a task instruction portion, a case summary portion, and an output format specification portion with labeled section delimiters;
input the structured input sequence to the generative neural network model to obtain output character sequence data;
parse the output character sequence data by detecting the labeled section delimiters to extract structured result objects comprising procedure list data, document list data, and draft text data;
populate electronic document templates with the draft text data and the structured attribute fields to generate electronic document data;
transmit, via the packet-switched network, at least one electronic document data item to an external system interface address; and
transmit, via the packet-switched network, remaining electronic document data and a progress state indicator to the terminal device for rendering on a display of the terminal device.

19. The system according to claim 18, wherein the circuitry is further configured to receive account credential data and service provider identifier data from the terminal device, generate a second structured input sequence encoding the service provider identifier data and an instruction character sequence for end-of-life account processing, input the second structured input sequence to the generative neural network model to obtain a formatted notification message, and transmit the formatted notification message to a service provider interface endpoint via the packet-switched network.

20. A method comprising:
receiving, via a packet-switched network, a plurality of heterogeneous data records from a terminal device, each heterogeneous data record comprising at least one natural language character sequence and a plurality of structured attribute fields associated with entity identifier data;
storing the plurality of heterogeneous data records in a storage device by indexing each heterogeneous data record with a case identifier;
applying a natural language processing operation to the at least one natural language character sequence to extract a set of structured feature data comprising entity attribute pairs and candidate classification labels with associated confidence score values;
determining, based on the set of structured feature data and a set of rule condition definitions stored in the storage device, a list of candidate procedure type codes satisfying respective rule condition predicates;
generating a structured input sequence for a generative neural network model by inserting values from the structured attribute fields, the set of structured feature data, and the list of candidate procedure type codes into a prompt template data structure comprising a role instruction portion, a task instruction portion, a case summary portion, and an output format specification portion;
inputting the structured input sequence to the generative neural network model to obtain output character sequence data;
parsing the output character sequence data according to the output format specification portion to extract a plurality of structured result objects comprising procedure list data, document list data, and draft text data;
mapping the plurality of structured result objects to internal data type codes and populating electronic document template data with the draft text data and the structured attribute fields to generate electronic document data; and
transmitting, via the packet-switched network, the electronic document data and a progress state indicator to a terminal device for rendering on a display of the terminal device.
